(19) United States
(12) Patent Application Publication
(10) Pub. No.: US 2003/0083114 A1
(43) Pub. Date: May 1, 2003

(54) Hardware configuration for a navigation control unit for a wireless computer resource access device, such as a wireless web content access device

(76) Inventors: Daniel Lavin, San Francisco, CA (US); Henriette Wendt, London (GB); David Kamien, Jerusalem (IL); Dominic De Vetta, London (GB)

Correspondence Address: ST. ONGE STEWARD JOHNSTON & REENS, LLC, 986 BEDFORD STREET, STAMFORD, CT, 06905-5619, US

(21) Appl. No.: 10/269,156

(22) Filed: Oct. 11, 2002

Related U.S. Application Data
(63) Continuation of application No. PCT/US01/12167, filed on Apr. 12, 2001.

(30) Foreign Application Priority Data
Apr. 13, 2000 (GB) 0009004.3

(51) Int. Cl. H04M 1/00

(52) U.S. Cl. 455/569; 455/550

(57) ABSTRACT

A navigation control unit for use with, for example, a wireless web access device to access web content over a computer network, is disclosed. The navigation control unit includes a housing that encloses circuitry having a processor. A connector secured to the body connects the navigation control unit to a wireless access device. At least one user control, such as a button, is retained by the body, and at least a portion of it is accessible from outside the body. The processor and circuitry generate a user command based on actuation of at least one of the user controls.

### CROSS-REFERENCE TO RELATED APPLICATION

This application claims the benefit of U.K. Patent Application No. GB 0009004.3, filed Apr. 13, 2000, currently pending.

### TECHNICAL FIELD

The present disclosure relates in general to a navigation control unit for use with a wireless resource access device.

### BACKGROUND

The Internet comprises a vast number of computers and computer networks interconnected through communication channels. The Internet is used for a variety of reasons, including electronic commerce, exchanging information such as electronic mail retrieving information and doing research, and the like. Many standards have been established for exchanging information over the Internet, such as electronic mail, Gopher, and the World Wide Web (“CW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request); The request is forwarded to the web server that supports that web page. When that web server receives the request, it sends the requested web page to the client computer system. When the client computer system receives that web page, it typically displays the web page using a browser. A browser is typically a special-purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g., PDA's).

Recently, portable communication devices such as mobile telephones have been developed for access to information on a local or global computer network. These devices come in many different forms including, for example, a mobile telephone or a palm top computer, and will be referred to generally as a wireless web access device.

Customers of the wireless web access device desire to have devices that provide a large amount of functionality and yet are small, lightweight, and affordable. To accommodate these conflicting desires, manufacturers have made the user controls smaller and have made each user control perform potentially a variety of functions. For example, many wireless web access devices require users to press a small button up to three times in order to input just one character.

Moreover, users often have to navigate through a large number of web pages or levels of web pages, requiring a large number of often-cumbersome inputs. Accordingly, it is desired to increase both the functionality and ease of use of wireless web access devices.

U.S. Pat. No. 5,854,624 to Grant, issued Dec. 29, 1998 (“Grant”) discloses a pocket-sized user interface for accepting user input for a separate Internet browser terminal designed to, among other things, reduce carpal tunnel syndrome for people using traditional computer keyboards to browse the Internet on their personal computer. The user interface of Grant must be less than 0.45 inches in thickness and roughly the length, width, and shape of a standard credit card. The interface is connected to a browser terminal via a translator, which converts the commands to a form acceptable to the browser terminal, and the translator is preferably connected to both the browser terminal and the user interface with a cord. The buttons on Grant are programmed to provide linking commands to a variety of websites. The user interface of Grant, however, is plagued with problems. For example, the user interface Grant is severely limited in size, shape and functionality and requires the use of a translator. In addition, Grant only discloses buttons programmed on the user interface itself, limiting its usefulness relative to the present invention. These are only some of the problems associated with Grant.

Most wireless web access device users are unsophisticated in the operation of such devices, and thus have difficulty reconfiguring them to select a new home page (if this is possible), or even access other web pages. Even if users are capable of operating the device, navigating to desired web pages can be difficult, often involving a complex string of key presses. Thus, users find it difficult to customize their wireless web access devices, and find it difficult to navigate to desired web pages. Furthermore, many of the wireless web access devices are not general purpose computing devices, but instead are task driven for a small set of preferred tasks for the user, not for general browsing or web surfing. These tasks are horizontal across groups of people, such as electronic mail, calendar, address book, and the like. Content on the worldwide web, however, is much more segmented to specific user groups interested in the particular content provided by a particular site. Thus, there is a discontinuity between wireless web access devices, and the content to which they allow users access.

### BRIEF DESCRIPTION OF THE DRAWINGS

FIG. 1 is schematic view of a wireless web access device with a first preferred embodiment of a navigation control unit.

FIG. 2 is a schematic view of a second preferred embodiment of the navigation control unit

FIG. 3A is an isometric view of a third preferred embodiment of the navigation control unit.

FIG. 3B is a three-dimensional view and a side profile of a fourth preferred embodiment of the navigation control unit.

FIG. 3C is a front view and a side profile of a fifth preferred embodiment of the navigation control unit.

FIG. 3D is a front view of a sixth preferred embodiment of the navigation control unit.

FIG. 3E is a photograph of the front view of a seventh preferred embodiment of the navigation control unit.

FIGS. 3F-3AU are isometric views of a variety of preferred embodiments of the navigation control unit.

FIG. 3AV is an exploded, isometric wire frame view of another preferred embodiment of the navigation control unit.

FIG. 3AW shows a front view and an end view of a preferred embodiment of the navigation control unit.

FIG. 3AX shows alternative isometric views of the navigation control unit of FIG. 3AW.

FIGS. 3AY-3BG show exploded, isometric views of alternative embodiments of the navigation control unit if FIG. 3AW.

FIGS. 3BH-3BM show front views of preferred embodiments of the navigation control unit and the connector.

FIGS. 3BO-3DK depict isometric views of alternative embodiments of the navigation control unit.

FIG. 3DL depicts a cut-away side view of an alternative embodiment of the navigation control unit.

FIGS. 3DM-3DQ are isometric views of alternative packaging embodiments for marketing the navigation control unit.

FIG. 4 is a schematic view of a preferred control circuit of the navigation control unit.

FIG. 5 is a flowchart showing a preferred method of operation of the navigation control unit.

FIG. 6 is a flowchart showing a preferred method for providing higher level functionality in the navigation control unit.

In the drawings, identical reference numbers identify identical or substantially similar elements or acts. To easily identify the discussion of any particular element or act, the most significant digit or digits in a reference number refer to the Figure number in which that element is first introduced (e.g., element 1104 is first introduced and discussed with respect to FIG. 11).

A portion of this disclosure contains material to which a claim for copyright is made. The copyright owner has no objection to the facsimile reproduction by anyone of the patent document or the patent disclosure (including Figures), as it appears in the Patent and Trademark Office patent file or records, but reserves all other copyright rights whatsoever.

The headings provided herein are for convenience only and do not necessarily affect the scope or meaning of the claimed invention.

### DETAILED DESCRIPTION

The following description provides specific details for a thorough understanding of, and enabling description for, embodiments of the invention. However, one skilled in the art will understand that the invention may be practiced without these details. In other instances, well known structures and functions have not been shown or described in detail to avoid unnecessarily obscuring the description of the embodiments of the invention.

Depicted embodiments of the present invention are intended for use with any suitable portable wireless web access device. By way of example, the preferred embodiments will be described with reference to a wireless web access device 110, such as a mobile telephone, Internet-enabled PDA, automobile-based web access device, or other portable or mobile communication devices. In a preferred embodiment, the wireless web access device 110 is a cellular telephone such as a GSM device, preferably operating under the wireless application protocol (WAP), GPRS, 3G, I-Mode, or other similar communications protocol. The wireless web access device 110 typically has a display screen 111 and integral user controls 112 which are suitably buttons such as membrane switches. In addition, the wireless web access device 110 can be used to access any sort of computer resources, not only web pages, and could also be called a wireless computer resource access device 110.

Under a communications protocol such as WAP, the wireless web access device 110 is used to access a wide range of information on databases linked by a global computer network such as the Internet. The wireless web access device 110 uses a browser function to access the Internet 115 through a gateway portal 114. Navigation between sites and between pages of a site is performed using the integral user controls 112 to control a browser function of the wireless web access device 110. Often it is desired to make the wireless web access device 110 as small as possible and a problem arises in that the integral user controls 112 become smaller and more difficult to operate. Further, it is desired to keep the number of user controls to a minimum for space and cost, but by contrast it is also desired to increase the number of functions available on the device. As a result each integral user control 112 typically performs a number of different functions often operated by pressing the same button several times or by pressing control buttons in various different combinations. Often, a user must navigate a menu structure in order for the web access device to perform a desired function. It has been found that a menu structure having more than one or two levels is particularly difficult for users to navigate.

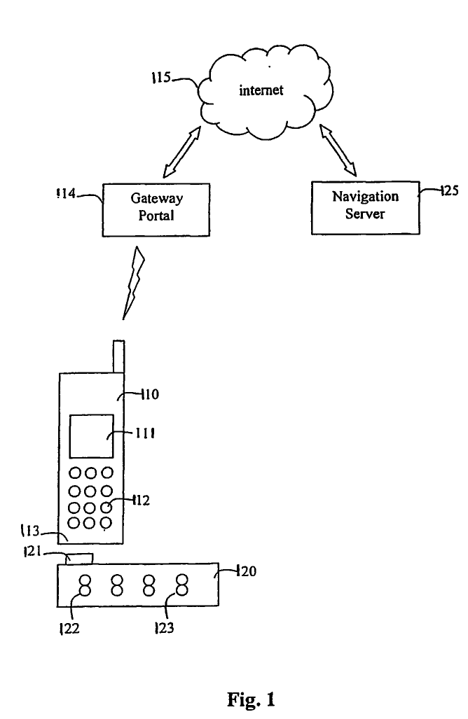

Referring to FIG. 1, in a first preferred embodiment the present invention provides a navigation control unit 120 that is coupleable to the wireless web access device 110. In this embodiment, the navigation control unit 120 is coupleable directly to the wireless web access device 110 such as by a connector 121 entering a corresponding port 113 on the wireless web access device 110. The connector 121 provides both electrical and mechanical coupling between the navigation control unit 120 and the web access device 110. The navigation control unit 120 is supported closely adjacent to the web access device 110. The port 113 in this example is shown at the bottom of the wireless web access device 110, but can be provided elsewhere on the device or remote therefrom such as on an adapter lead.

Unless described otherwise below, the construction and operation of the various blocks shown in FIG. 1 and the other Figures are of conventional design. As a result, such blocks need not be described in further detail beyond that provided herein, because they will be understood by those skilled in the relevant art. Such further detail is omitted for brevity and so as not to obscure the detailed description of the invention. Any modifications necessary to the blocks in FIG. 1 (or other Figures and embodiments) can be readily made by one skilled in the relevant art based on the detailed description provided herein.

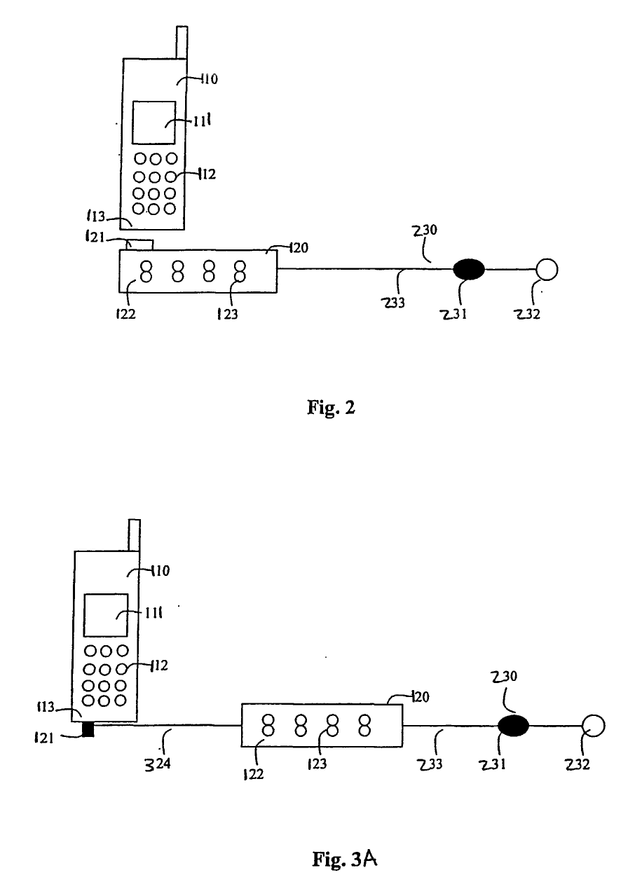

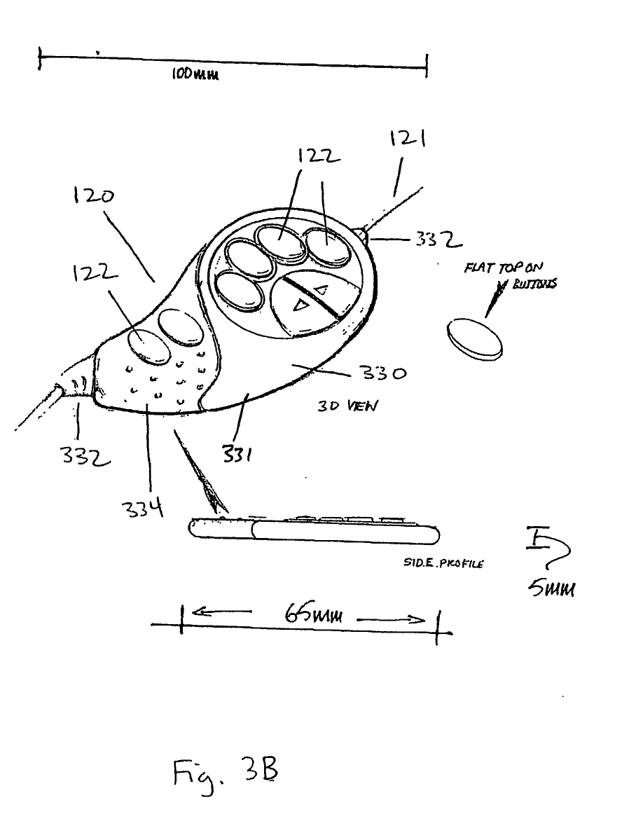

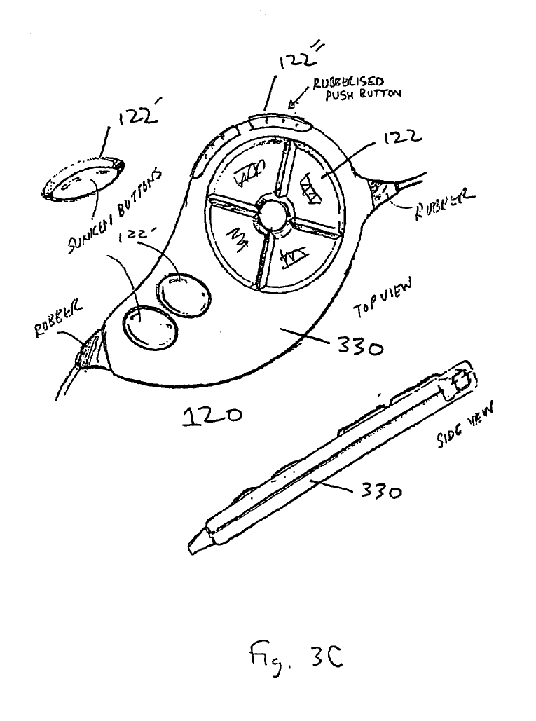

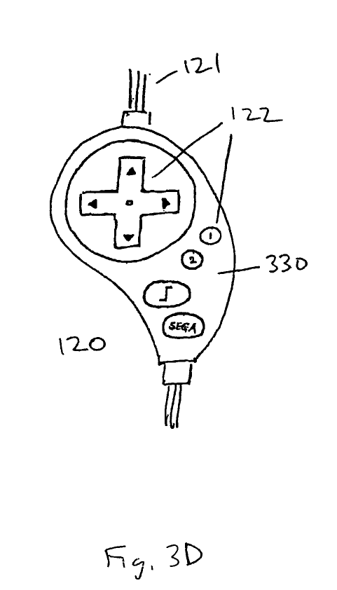

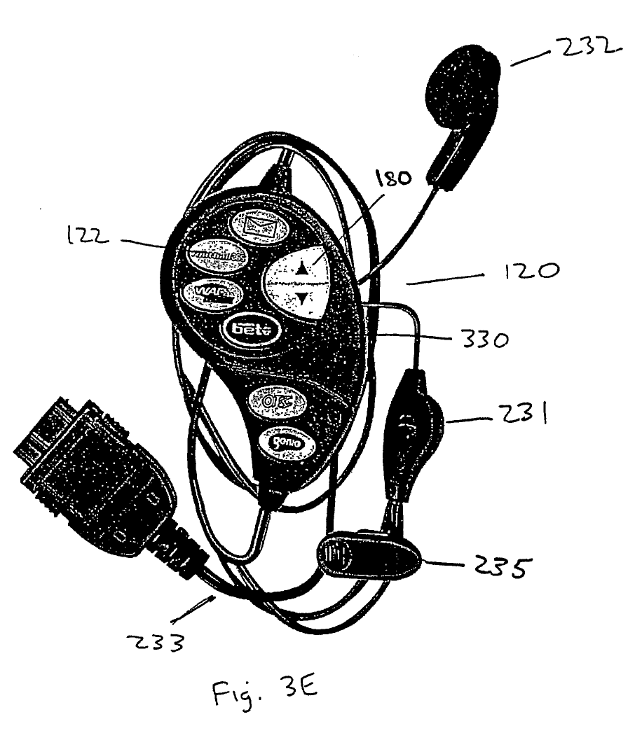

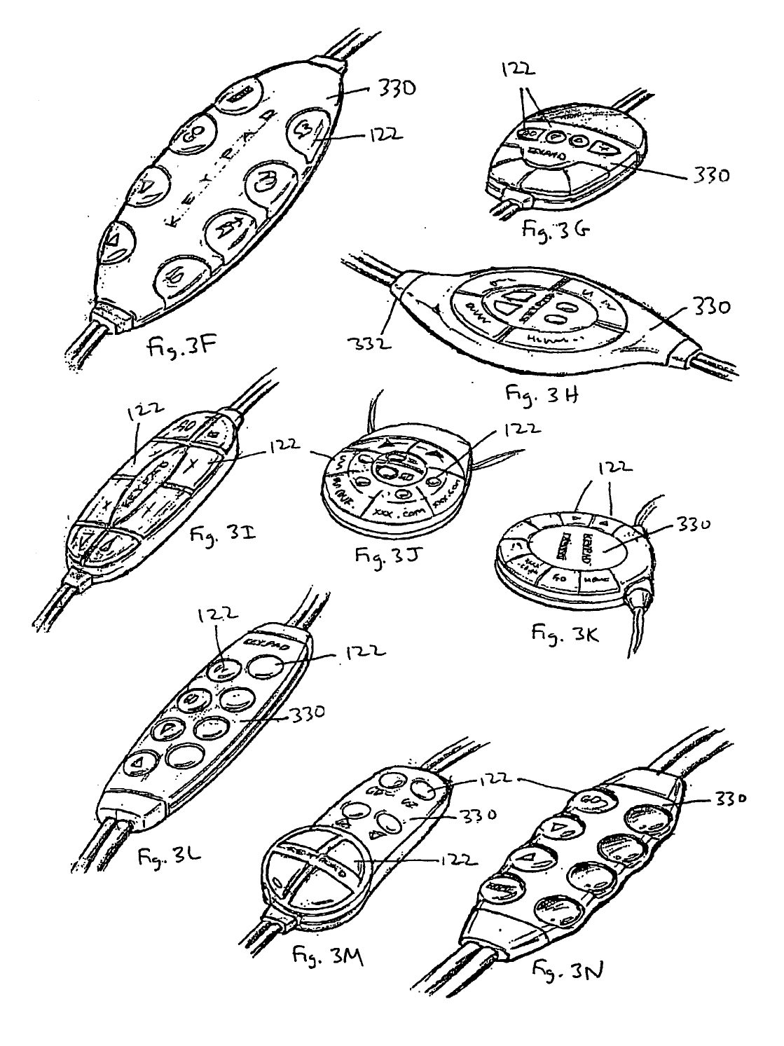

FIG. 2 shows a second preferred embodiment wherein the navigation control unit 120 comprises a handsfree unit 230 including a microphone 231 and an earpiece 232. Suitably, the handsfree unit 230 is coupled to the navigation control unit 120 by a communication link 233, such as a cord. Alternatively, a local wireless link is provided for communication between the navigation control unit 120 and the handsfree unit 230, such as by using optical infrared or radio frequency signals.

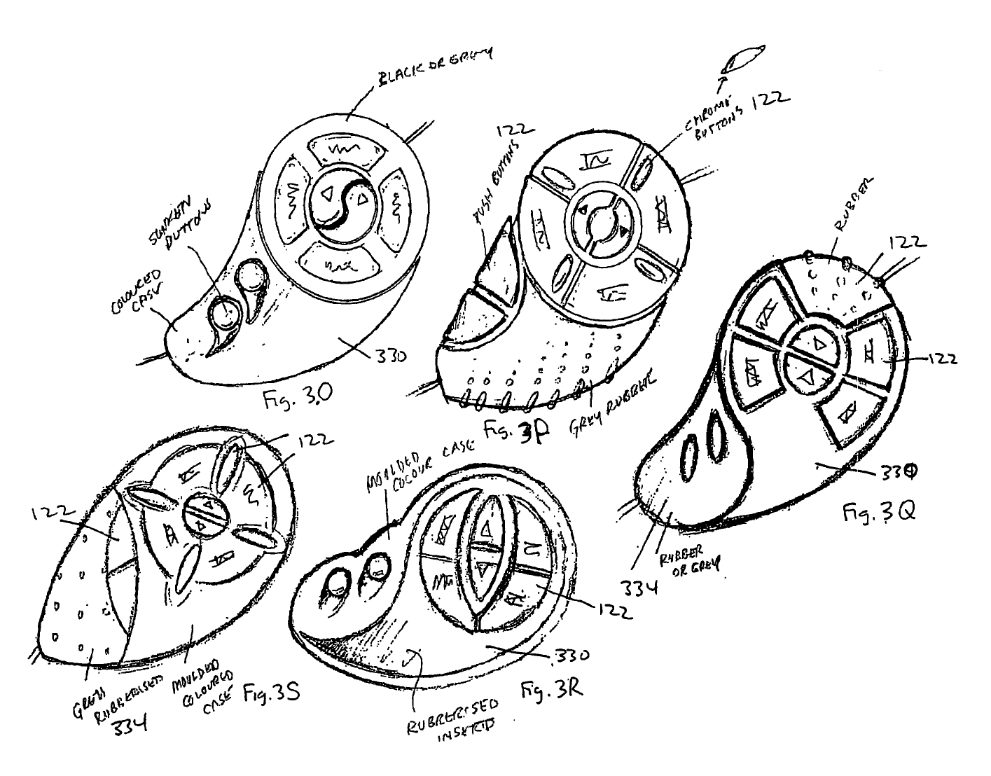

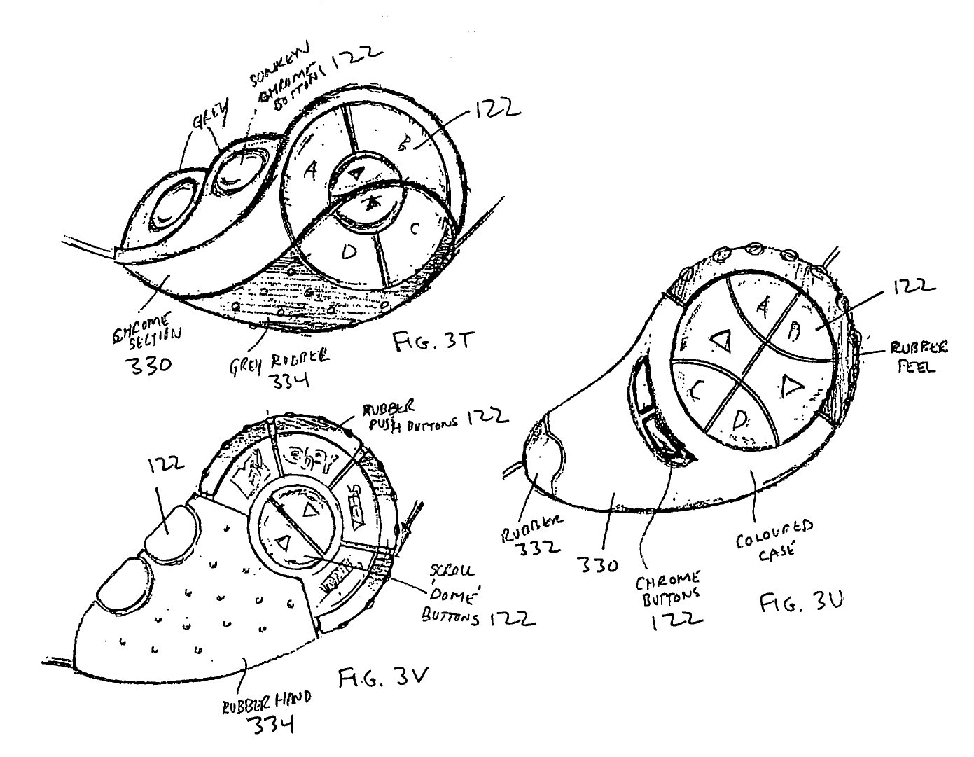

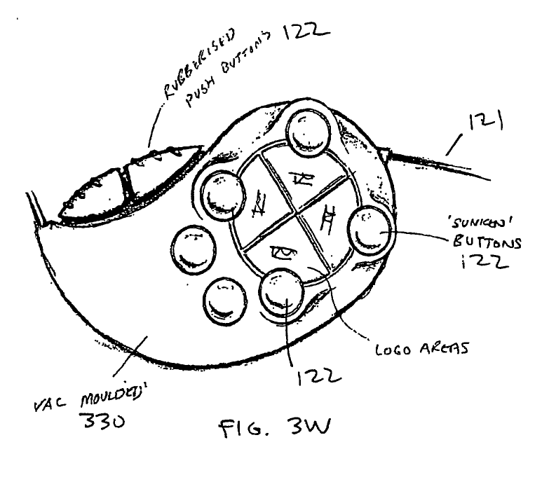

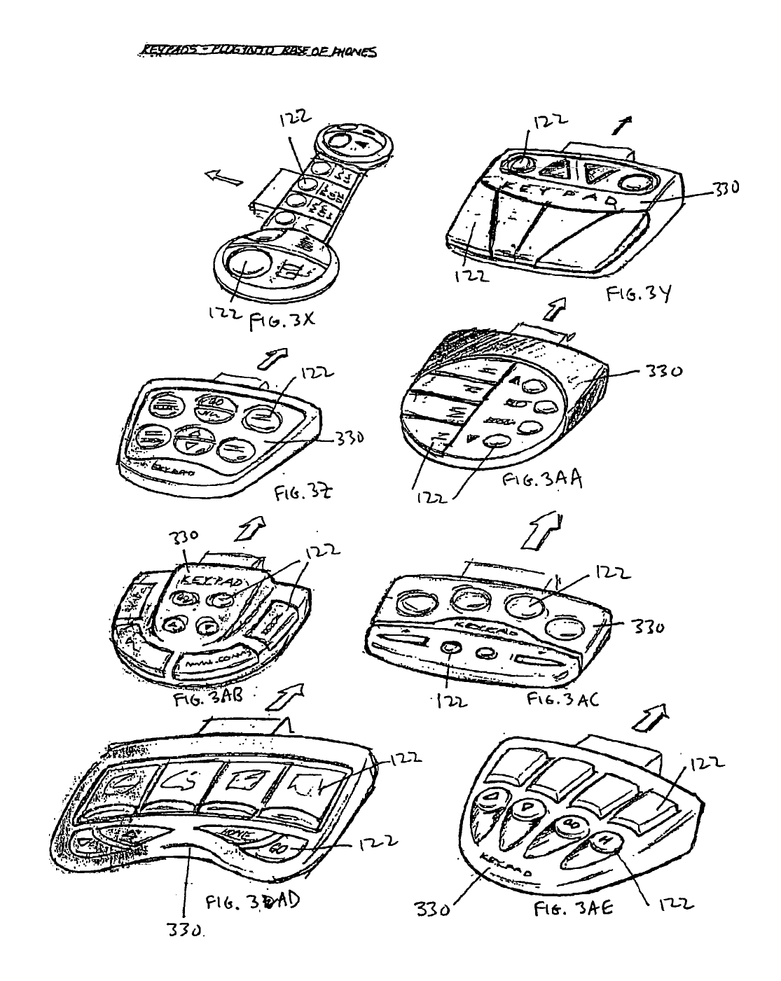

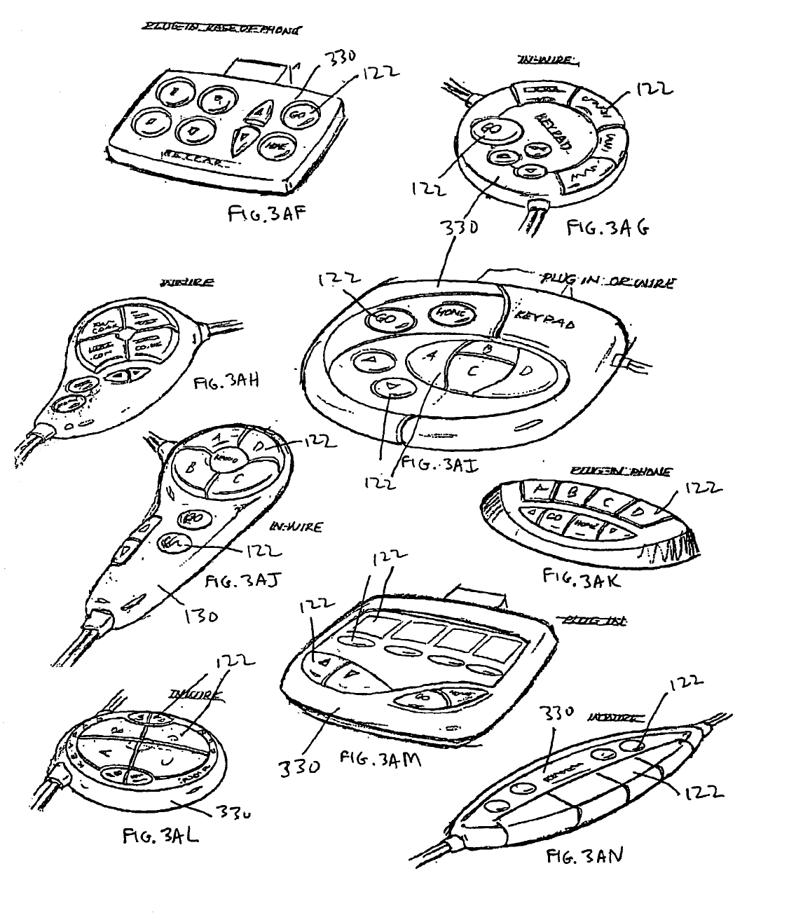

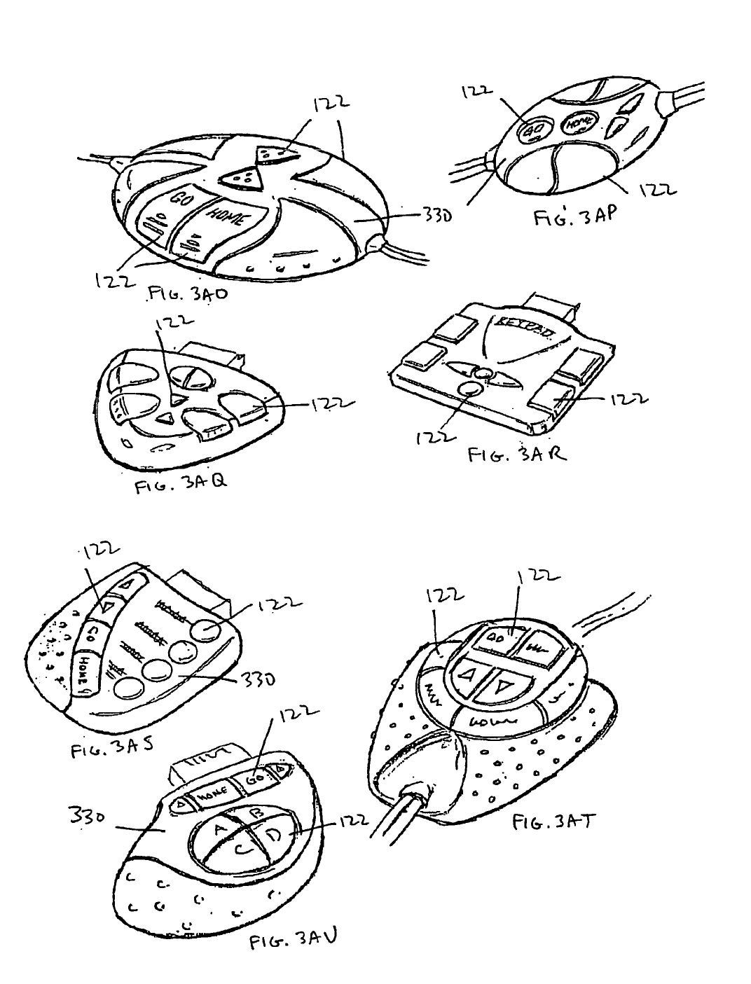

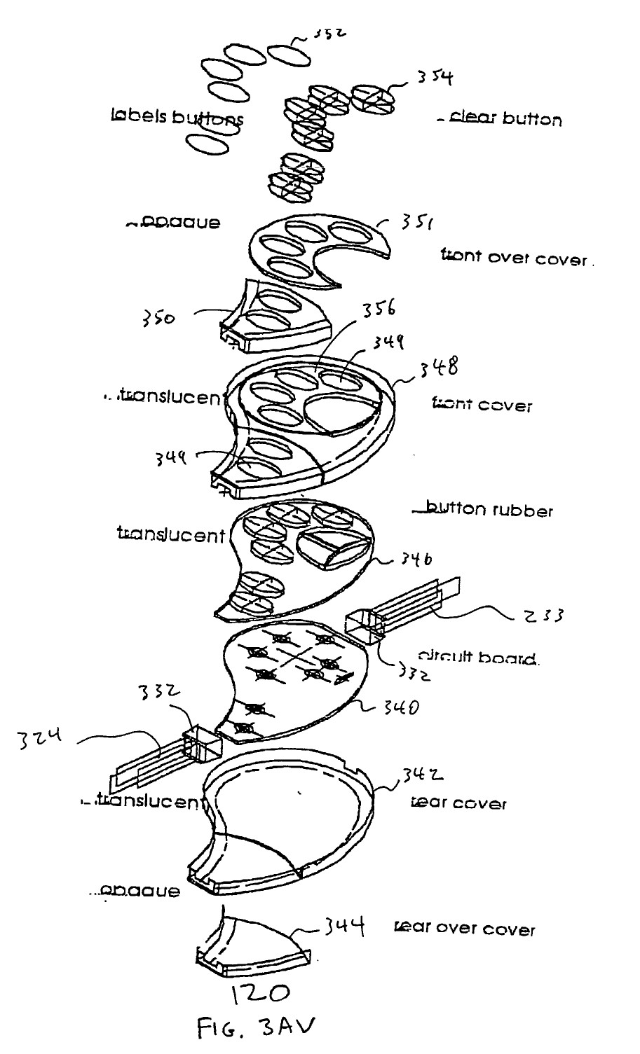

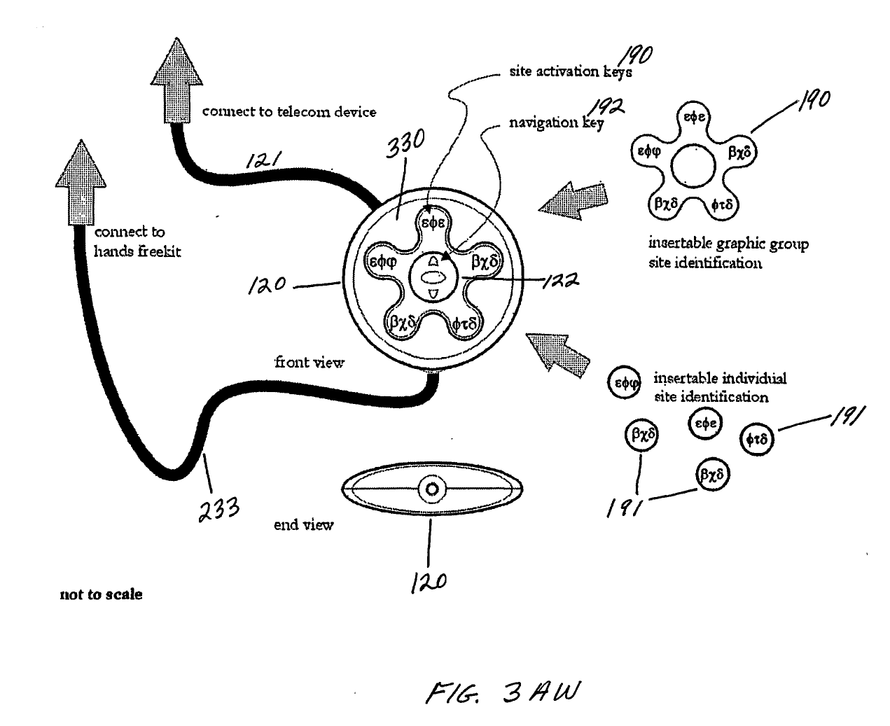

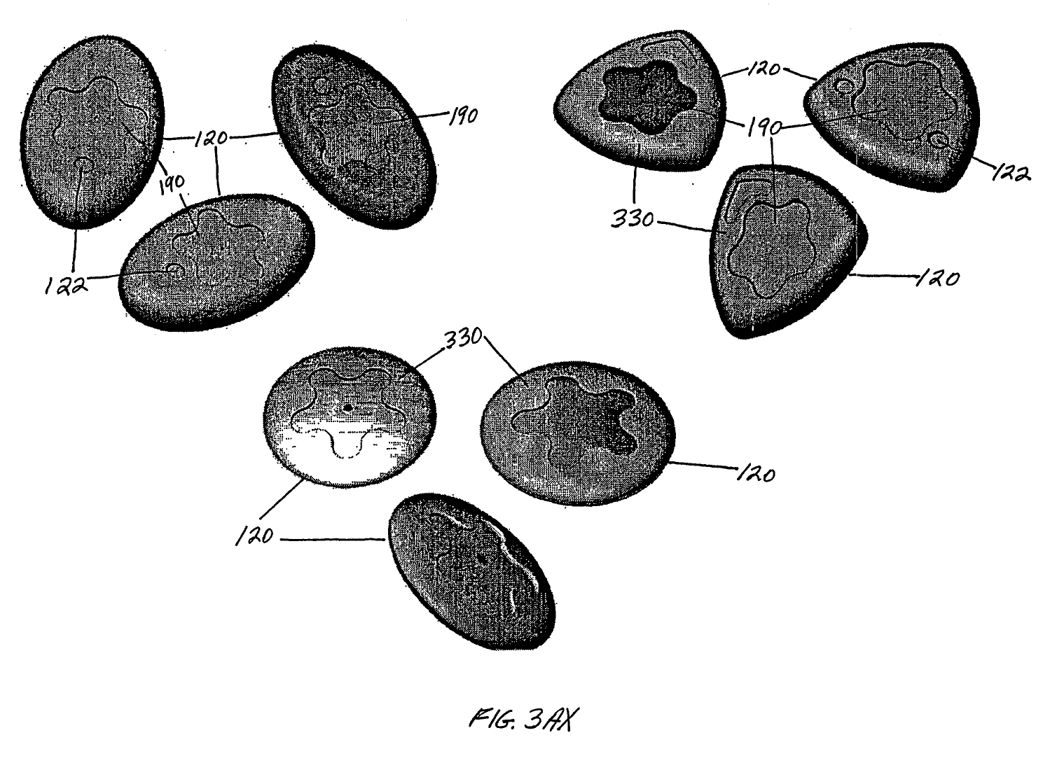

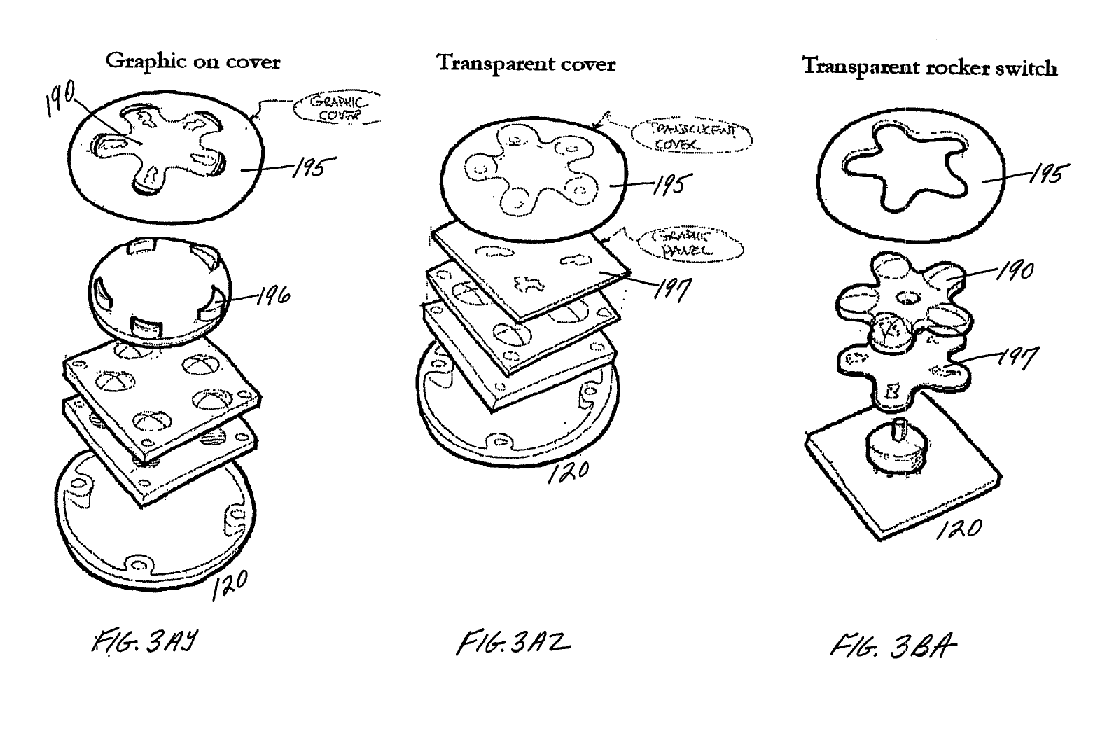

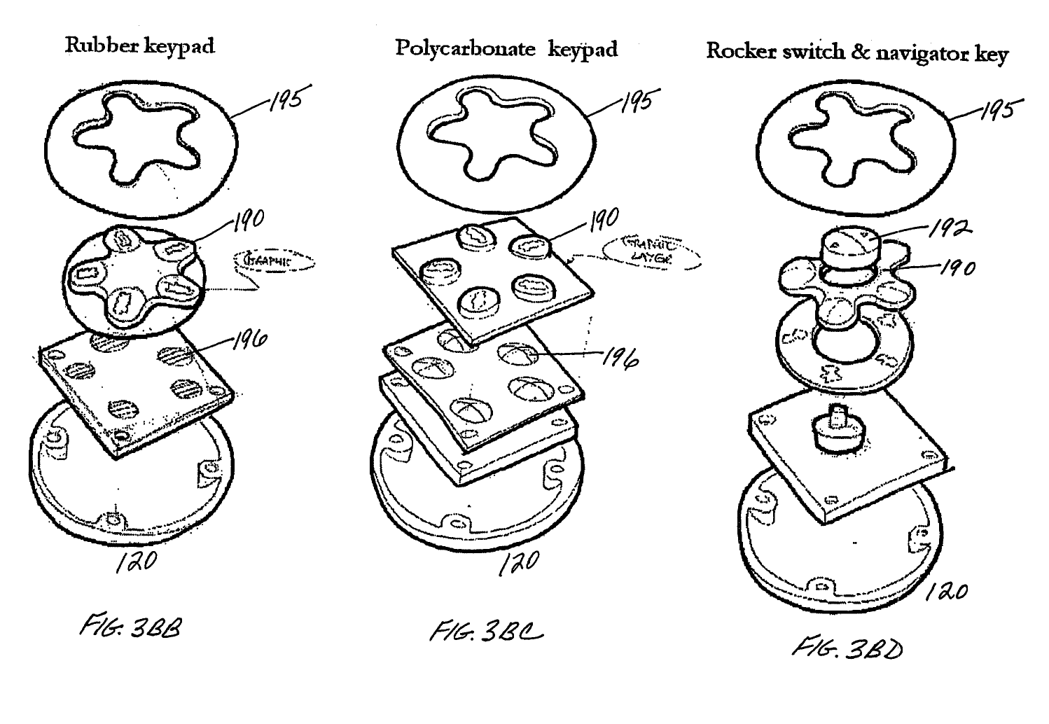

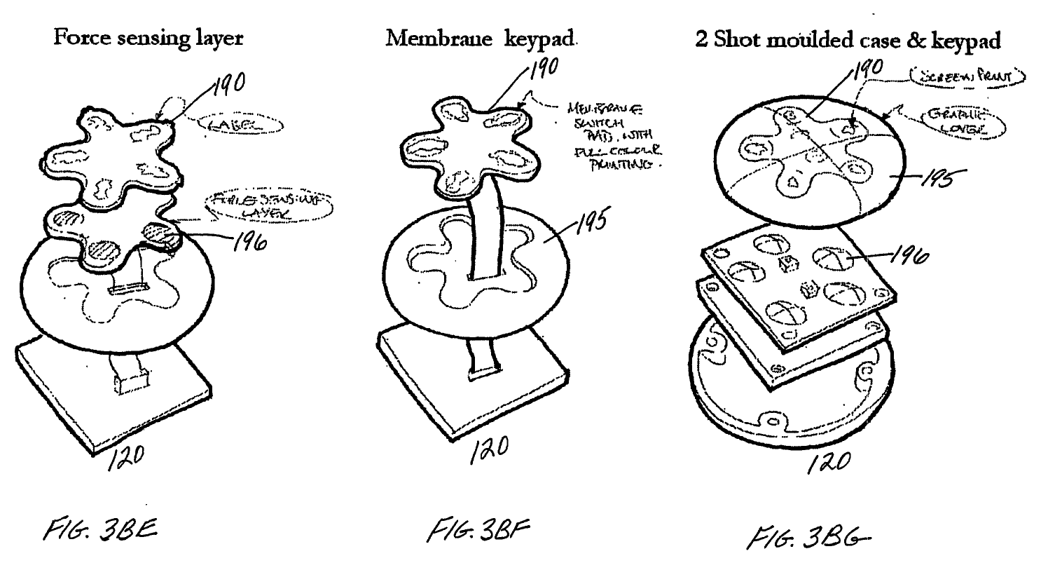

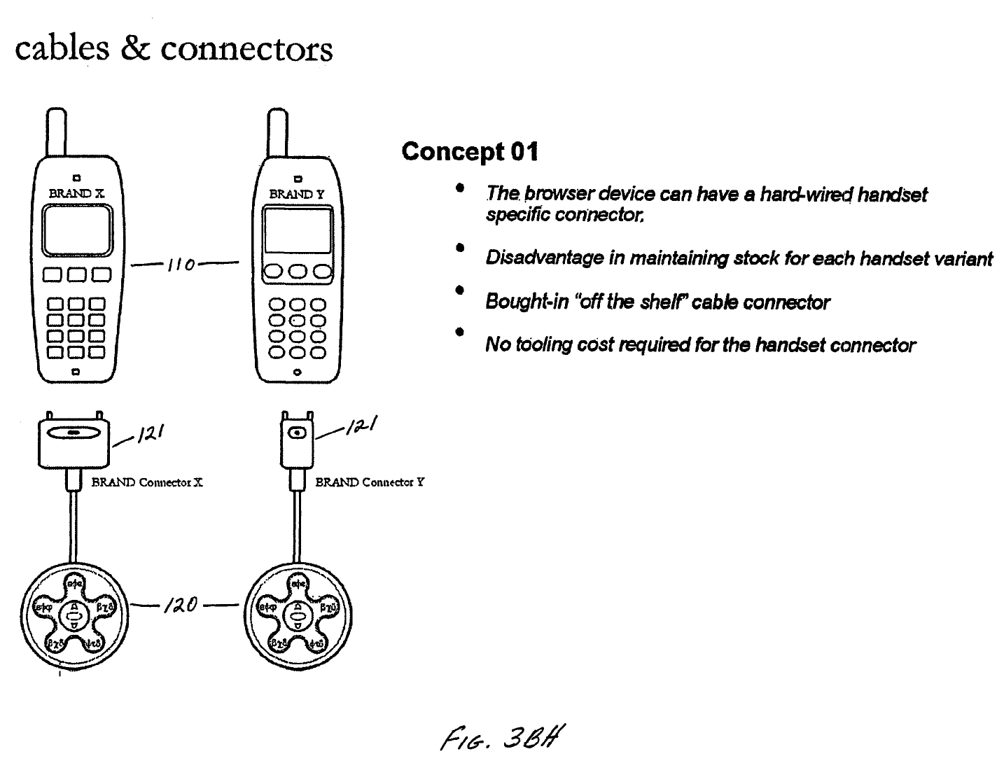

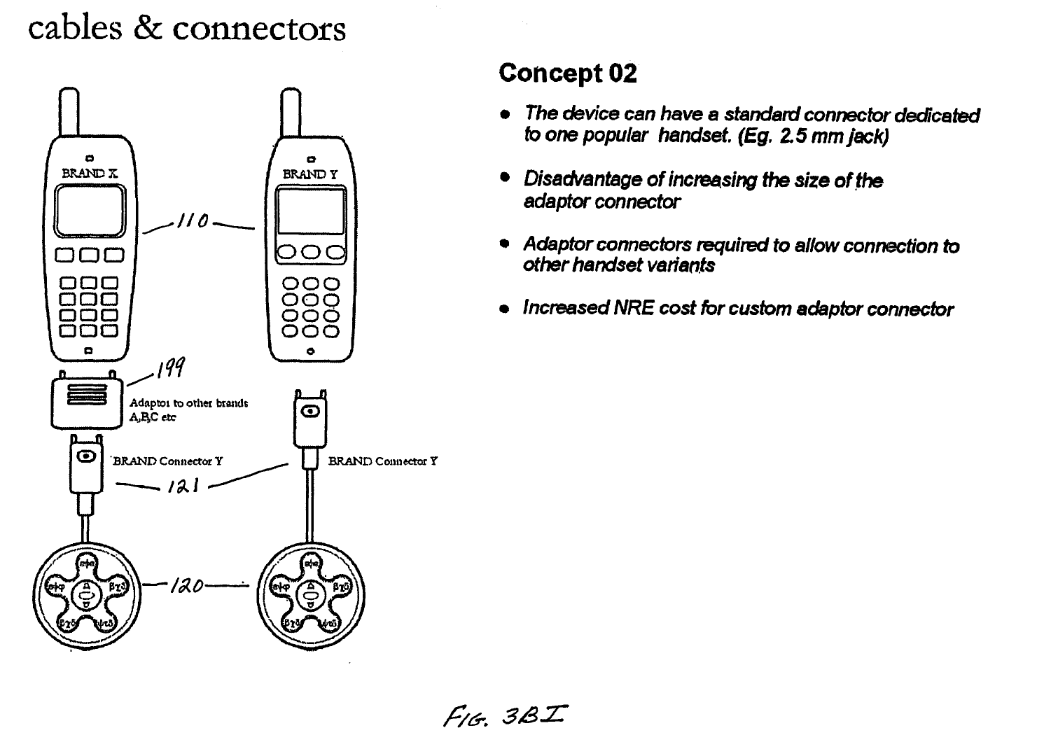

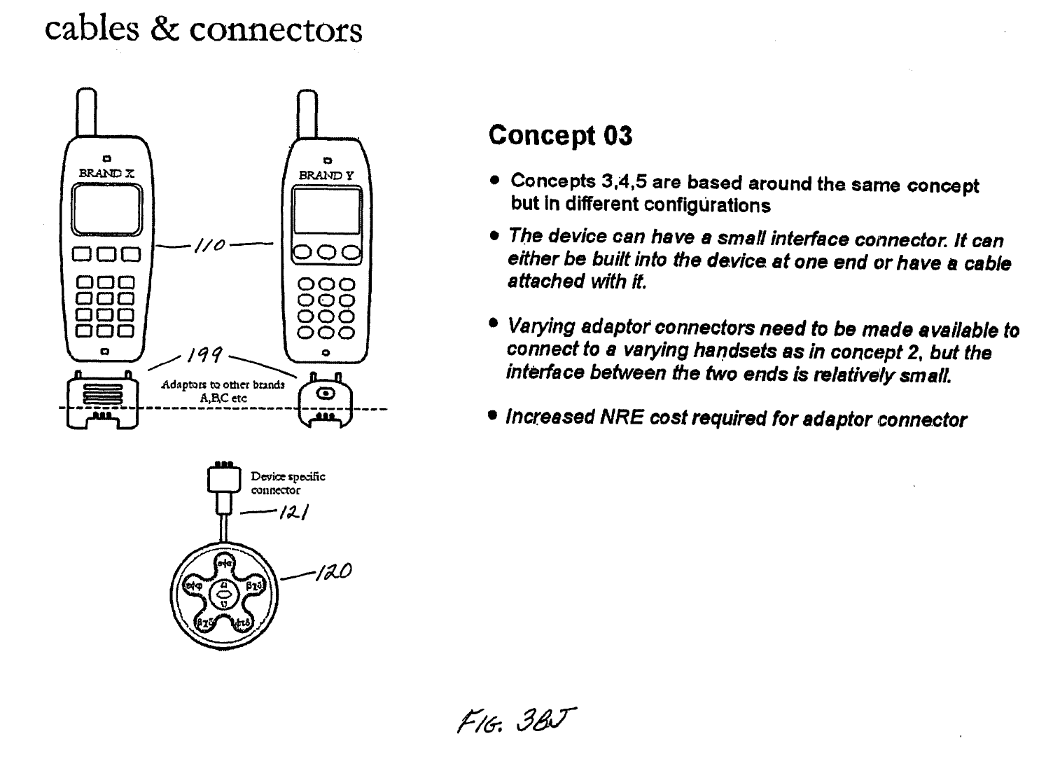

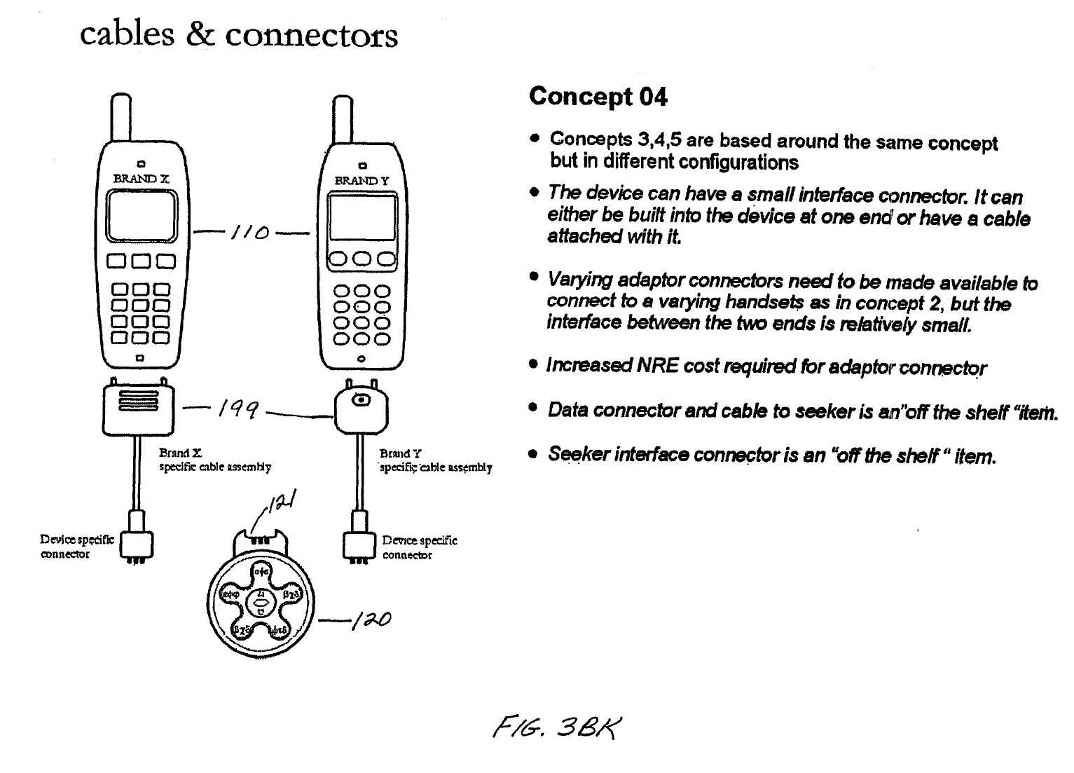

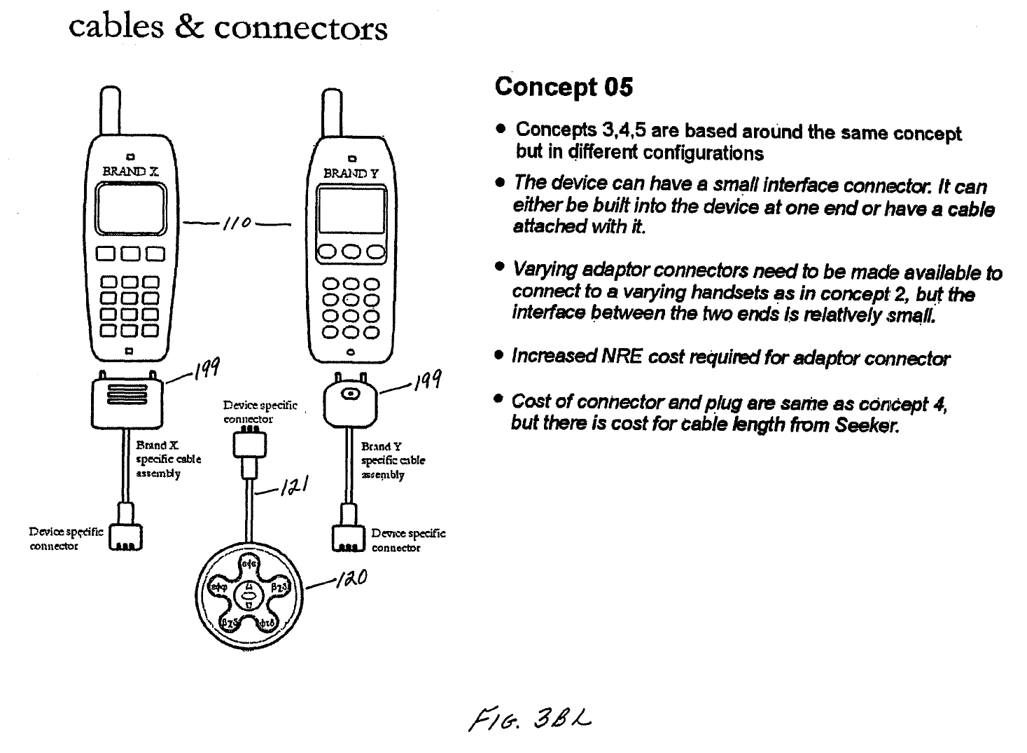

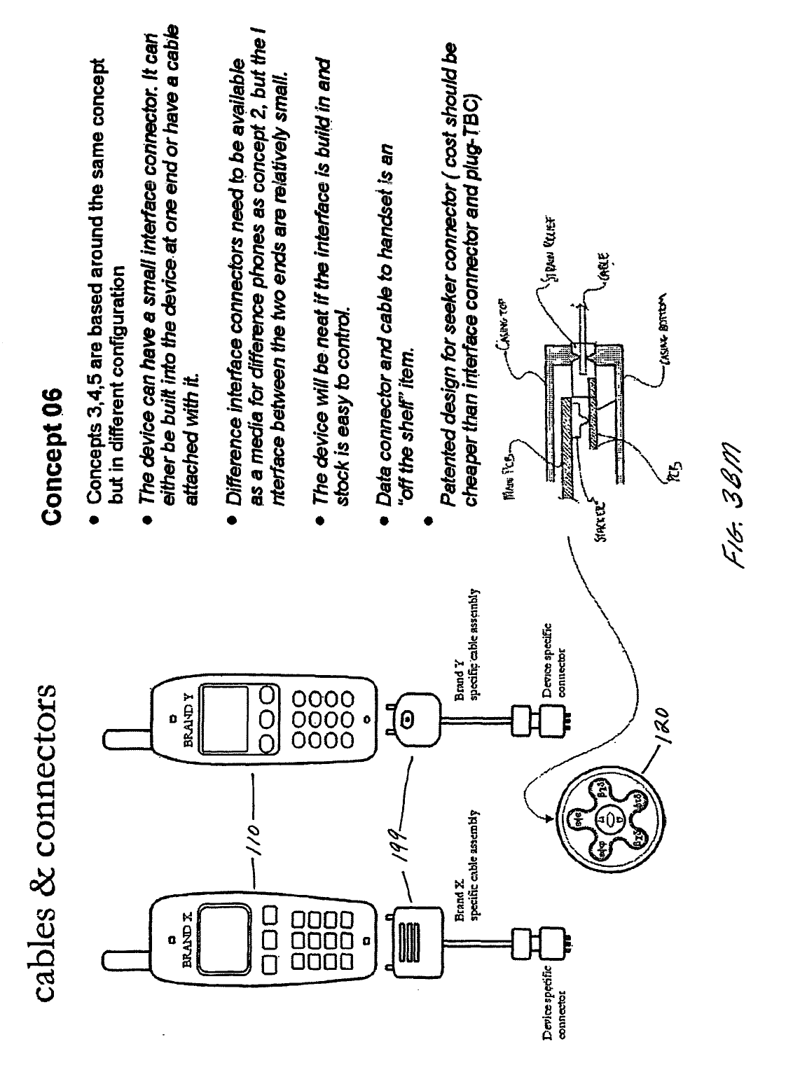

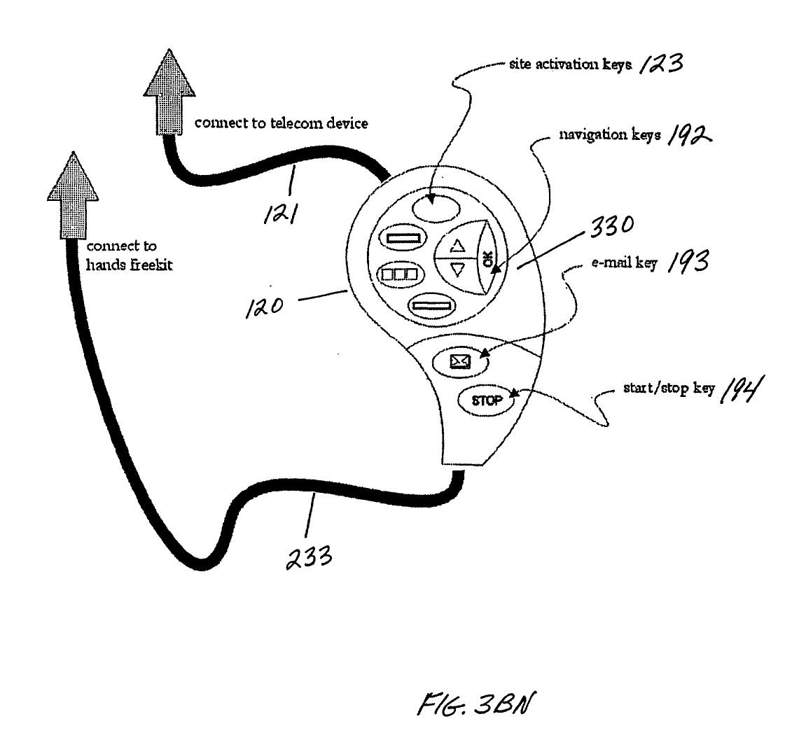

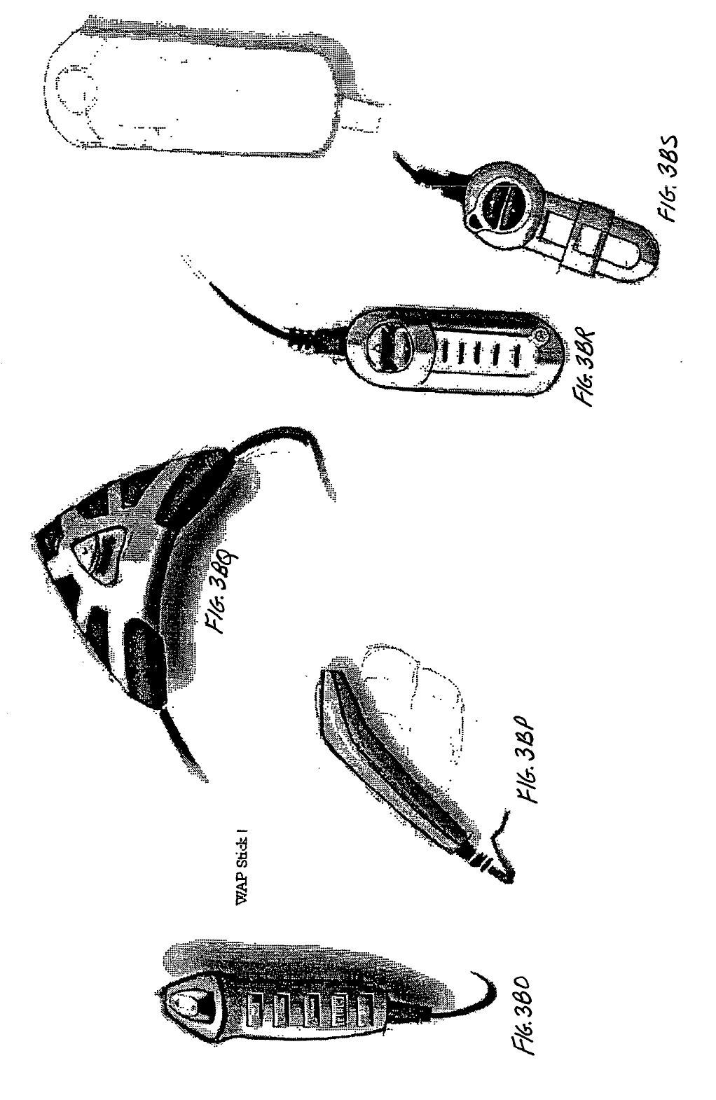

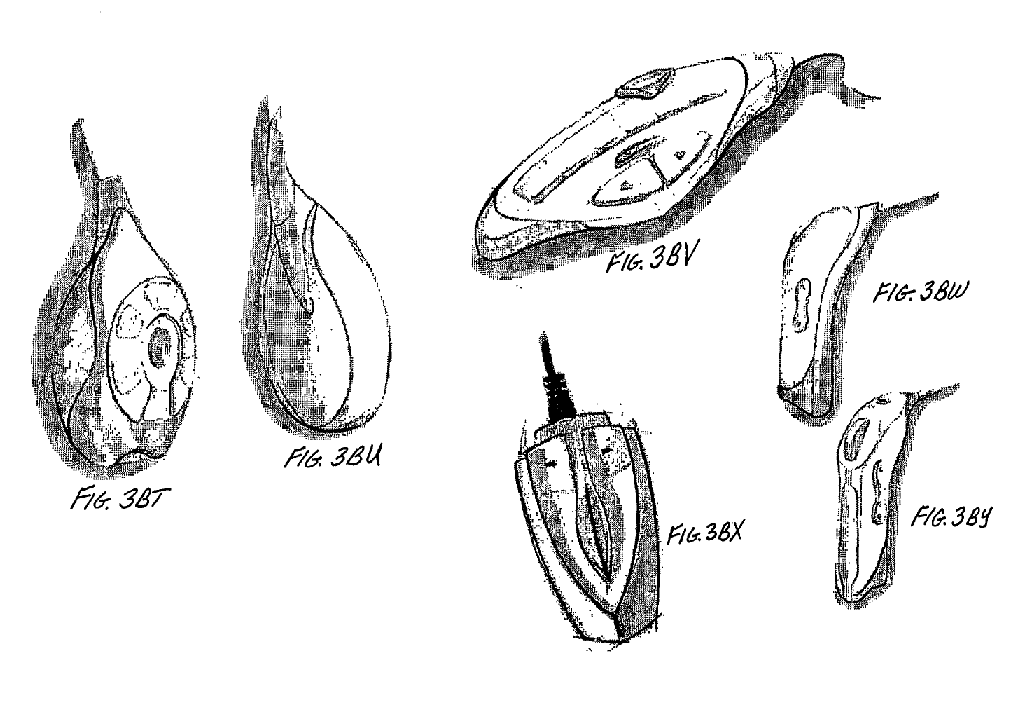

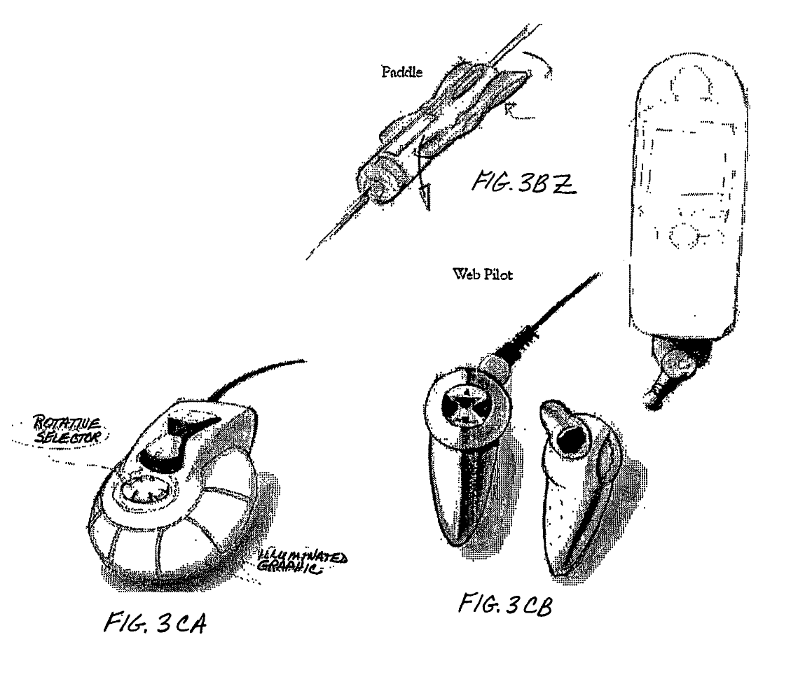

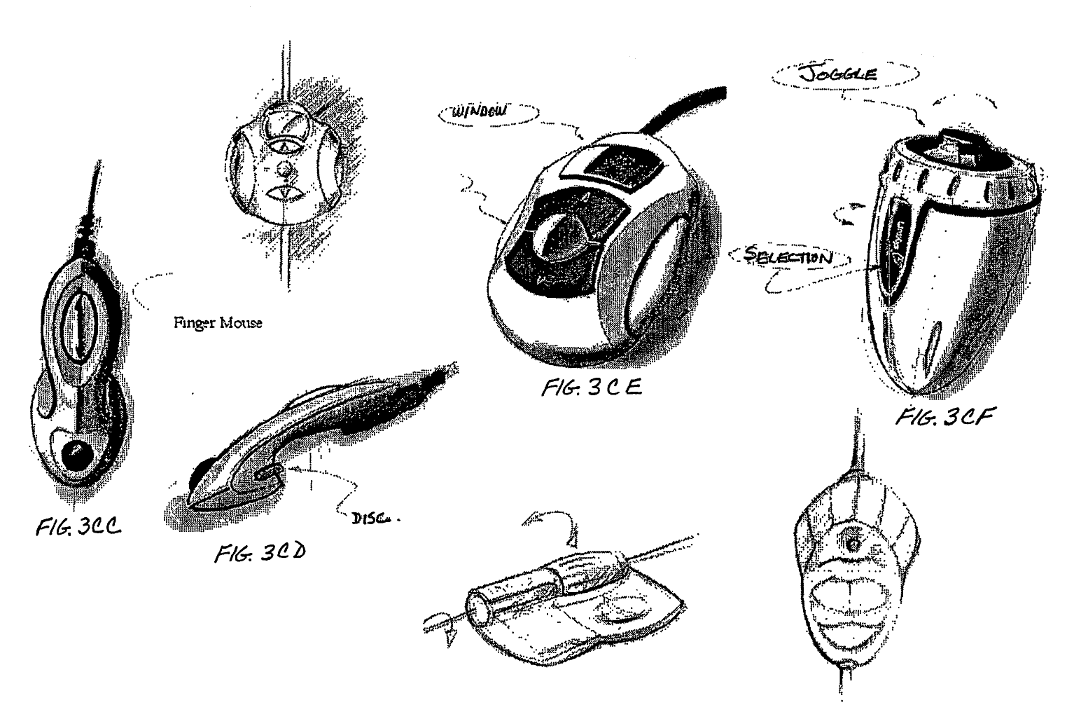

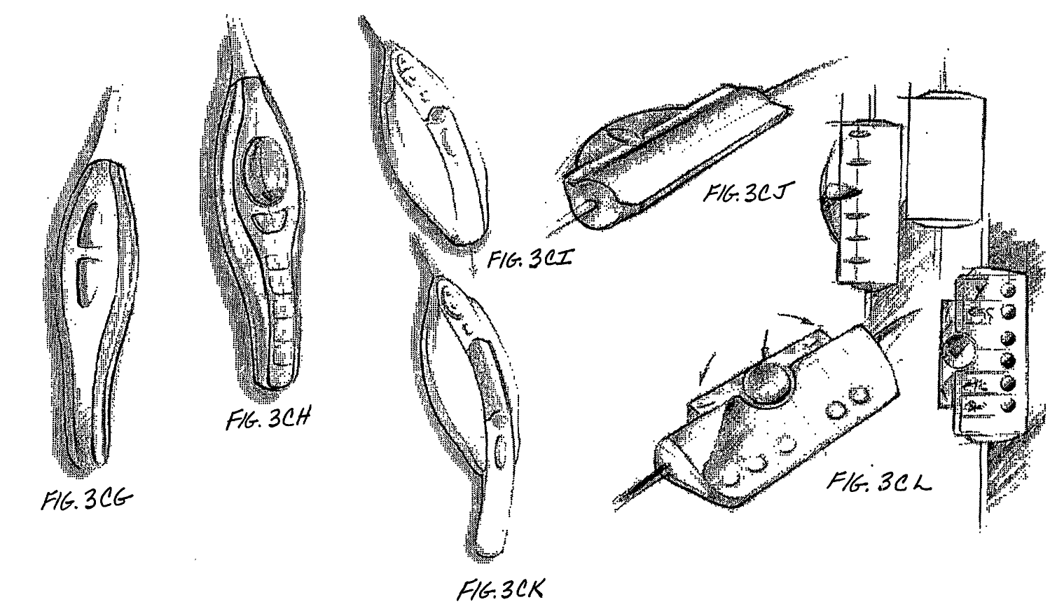

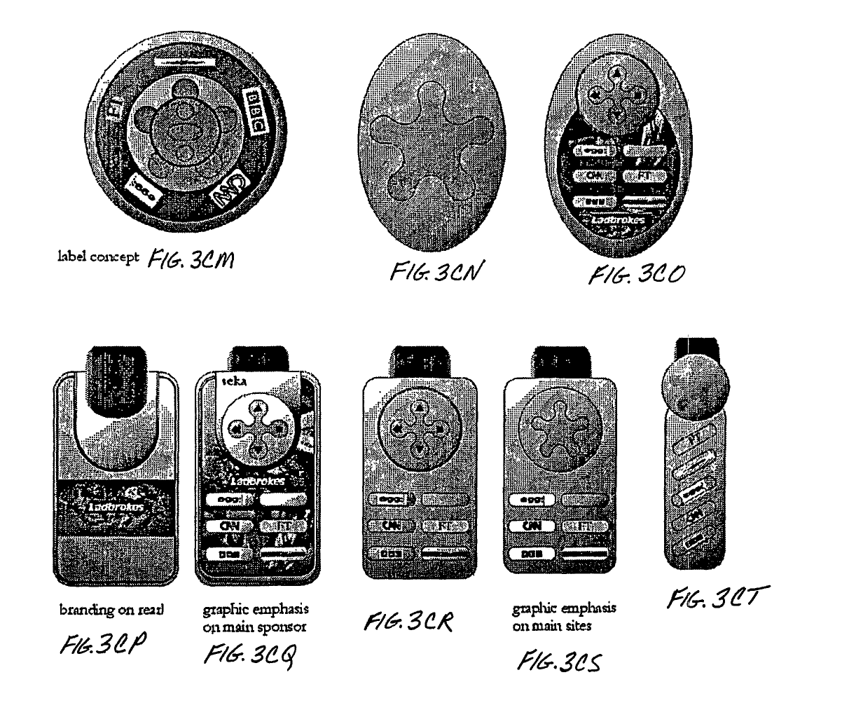

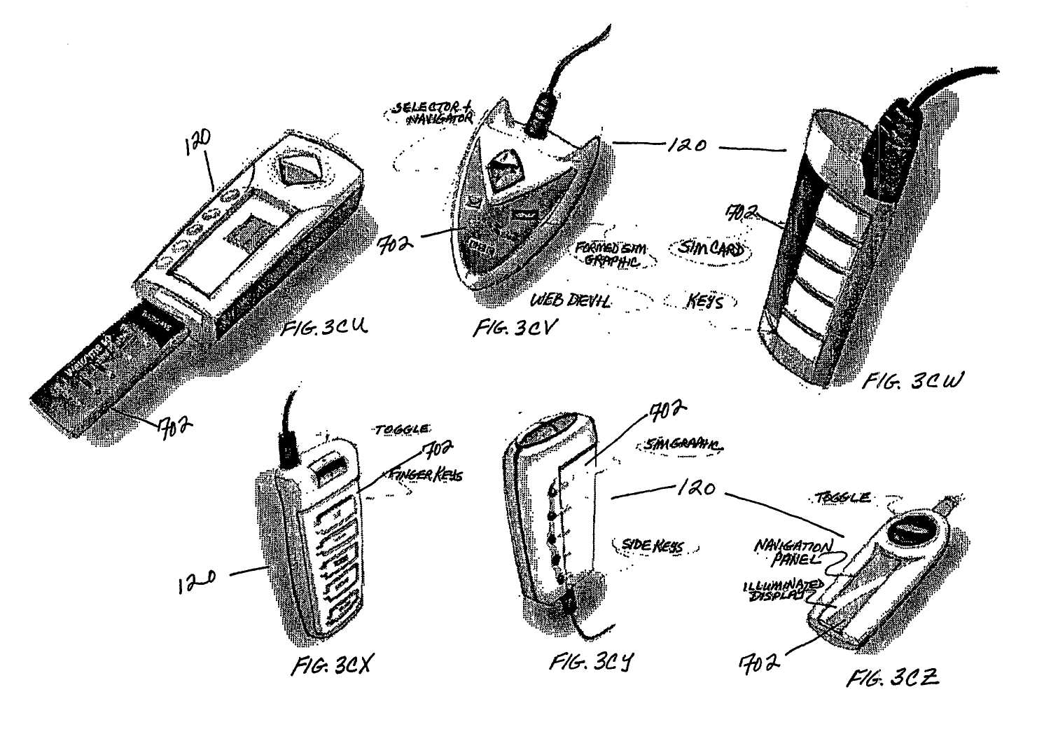

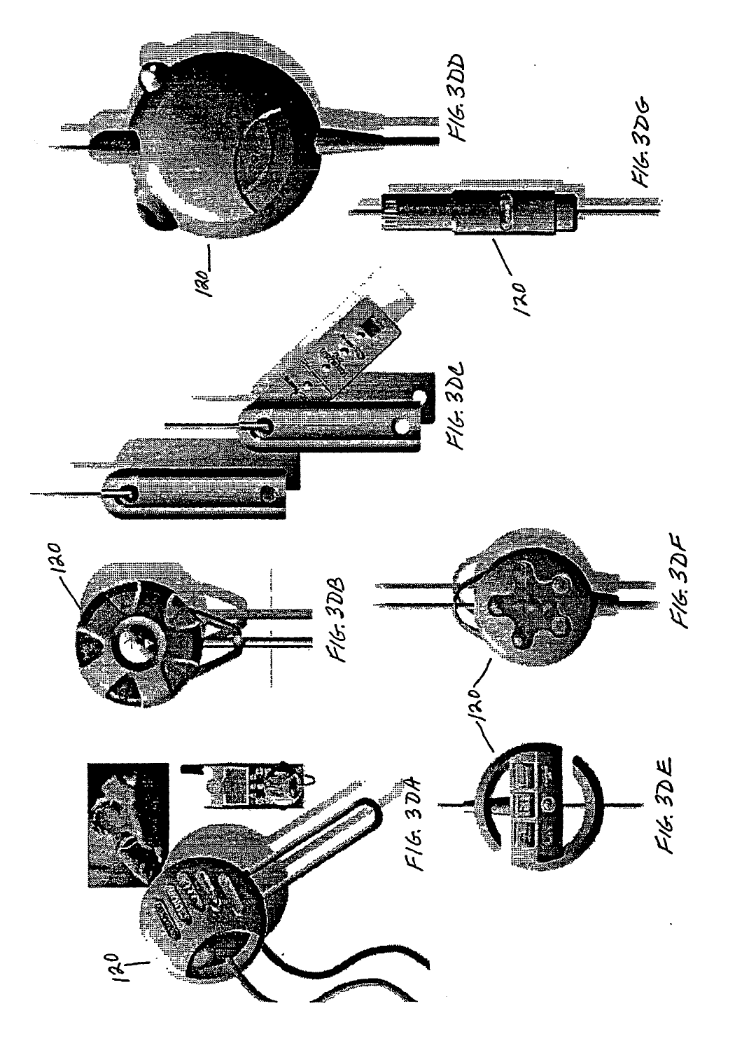

FIG. 3A shows a third preferred embodiment where the navigation control unit 120 is provided remote from the wireless web access device 110 inked by a communication link 324, such as a cord or a local wireless link. Conveniently, in this embodiment the wireless web access device 110 may be carried about a user's person such as in a pocket, the navigation control unit 120 may be carried separately such as in the hand, on a belt or on a jacket lapel, and the handsfree unit 230 may be provided about the user's head.

In an alternative embodiment, the navigation control unit 120 may be attached to a replaceable part of wireless web access device 110, such as a battery pack. In this example, the battery pack and navigation control unit 120 could be packaged and sold together to create a potentially more desirable product. Similarly, any replaceable part related to the wireless web access device 110, such as antennas or removable attachments, could be packaged with a navigation control unit 120.

The navigation control unit 120 may take any suitable form factor. A generally rectangular box is shown in FIGS. 1, 2 and 3A merely for illustration. The navigation control unit 120 may take any suitable size. In the first and second embodiments, at least the part of the navigation control unit 120 in the region of the connector 121 is sized and shaped to correspond with external contours of the wireless web access device 110 in the region of the port 113, giving a neat visual appearance and assisting mechanical stability.

In other alternative embodiments, the navigation control unit 120 may take other form factors, such as a watch or pen. This may be particularly useful in embodiments where the navigation control unit 120 is connected to the wireless web access device 110 via a remote wireless link.

The navigation control unit 120 provides at least one user control 122, and preferably a plurality of user controls as illustrated. These user controls 122 on the navigation control unit 120 are remote from the integral control buttons 112 provided on the web access device 110. The user controls 122 may take any suitable form, and in one preferred embodiment are keys such as membrane switches.

Unless described otherwise herein, the blocks depicted in FIGS. 13A and many of the other Figures, are well known or described in detail in the above-noted and cross-referenced patent application. Indeed, much of the detailed description provided herein is explicitly disclosed in the above patent application; most or all of the additional material of aspects of the invention will be recognized by those skilled in the relevant art as being inherent in the detailed description provided in such patent application, or well known to those skilled in the relevant art. Those skilled in the relevant art can implement aspects of the invention based on FIGS. 1-3A and the detailed description provided in the patent application.

FIG. 3B depicts an isometric view of one embodiment of the navigation control unit 120. In this embodiment, the body 330 of the navigation control unit 120 is constructed as an ultrasonically-welded clamshell. The body 330 can be made of any suitable material, including any material suited for the injection-molding plastic process, such as poly-carbonate-based plastics (PC/ABS). Alternatively, the body 330 can be made of rubber, metal, other plastics, or any other material with satisfactory ergonomic and durability properties. The body 330 can have any type of finish or paint, including but not limited to a rubber-shot finish using thermoplastic rubber, a chrome finish, a high shine finish, a satin finish, a matte finish, a transparent or semi-transparent finish, and a metallic finish or paint.

In one embodiment, the outer surface 331 of the body 330 is partially covered by a mat 334, which is preferably made of rubber or elastomer. The mat 334 can also be made of any suitable material, including plastics, metal, silicon, and can be provided with any finish or color. The mat 334 can provide improved ergonomics and can optionally be provided with an uneven surface that further improves ergonomics, such as by having small bumps on the mat 334 that improve the user's grip on the navigation control unit 120.

In one alternative embodiment, a light source (not pictured) within the navigation control unit 120 provides backlighting to the displays on the body 330. For example, any user controls 122 could be backlighted to provide improved visibility.

In other embodiments, the body 330 can be modified to accept removable devices or chips. Any of a wide range of devices or chips can conceivably be inserted into the navigation control unit 120, including memory sticks, Bluetooth-enabled cards, removable chips, electronic cash devices, electronic commerce devices, electronic wallet devices, location-determining devices such as GPS receivers, beepers, etc.

Grommets 332 can be used at the location where the body 330 connects with a connector 121 in order to provide an improved aesthetic appearance, to prevent foreign objects from interfering with operation of the navigation control unit 120, and for strain relief of the cords or wires. In one embodiment, grommets 332 are made of thermoplastic rubber, but can be made of any suitable material, such as plastic or fabric.

Many configurations of the navigation control unit 120 are possible. In one preferred embodiment, described in reference to FIG. 2, the navigation control unit 120 is connected or attached directly to the wireless web access device 110. In this embodiment, the navigation control unit 120 is attached directly to the mobile wireless device 110 such that the two items are substantially rigid with respect to each other. In one embodiment, the length along the longitudinal axis is approximately 60 mm (2.36 inches), the width is approximately 50 mm (2.97 inches), and the depth or thickness of the body 330 is approximately 8.3 mm (0.33 inches). Preferably, the approximate length along the longitudinal axis of the body 330 is between 20 mm and 100 mm (0.79-3.94 inches), the approximate width of the body is between 20 mm and 100 mm (0.7930 3.94 inches), and the approximate depth or thickness of the body 330 is between 3 mm and 20 mm (0.12-0.79 inches). Preferably, the width of the body 330 is approximately equal to the width of the wireless web access device 110 with which it is intended to be connected.

In another preferred embodiment, described in reference to FIG. 3A, the navigation control unit 120 is remote from the wireless web access device 110. The wireless web access device 110 is linked with the navigation control unit 120 by a communications link 324, such as a cord or a local wireless link, including radio, microwave, infrared, and any other form of communication. In this embodiment, a hands-free unit 230 is optionally coupled to the navigation control unit 120 by a communications link such as a cord 233 or local wireless link. In one embodiment, the length along the longitudinal axis is approximately 35 mm (1.38 inches), the width is approximately 25 mm (0.98 inches), and the depth or thickness of the body 330 is approximately 8 mm (0.31 inches). Preferably, the approximate length along the longitudinal axis of the body 330 is between 25 mm and 100 mm (0.98-3.94 inches), the approximate width of the body is between 15 mm and 50 mm (0.59-1.97 inches), and the approximate depth or thickness of the body is between 4 mm and 20 mm (0.16-.79 inches). In the wireless link embodiment, the maximum range is preferably no greater than approximately 10 feet in order to minimize operational requirements, but larger ranges are possible and within the scope of the invention.

In another preferred embodiment, the navigation control unit 120 provides a base platform. Individual customers could provide a custom accessory that either changes the appearance or functionality of the navigation control unit 120.

In another preferred embodiment, the navigation control unit 120 and body 330 are customized for a particular purpose, customer, or partner. For example, a company selling navigation control units 120 to facilitate Internet betting might design a navigation control unit 120 shaped like a horse, greyhound, playing card, or other gambling-related object. Similarly, a baseball team could sell a navigation control unit 120 shaped like a baseball bat or catcher's mitt. Such custom designs can increase the desirability of a navigation control unit 120 for customers. The links or URLs associated with the

Preferably, a navigation control unit 120 should have at least one means of accepting user input, such as a user control 122. As described herein, a user control 122 may provide any kind of user input, including a request to link to a web site, a scrolling or other control command, powering on or off, data entry, etc. The user control 122 can be of any acceptable design such as a flat plastic button that the user presses down (as depicted in FIG. 3A).

FIG. 3C depicts other embodiments of the user control 122, including a sunken button 122′ recessed below an upper surface of the body 330 and a rubberized push button 122″ located at an upper edge of the body 330. One of ordinary skill in the art would recognize that a wide variety of user controls 122 are possible and are within the scope of the invention.

FIG. 3D depicts another navigation control unit 120 where the user control 122 is a game playing device, such as a joystick or thumb pad. The user control 122 includes buttons, joysticks, rotary pads, sliders, or any other item used by a user to control the navigation control unit 120. One embodiment of the user control 122 has buttons with a clear plastic dome with paper underneath so that labels on the paper are visible underneath the button. Another alternative embodiment is using LCD screens for the user control 122, which may or may not be touch-screens. In this embodiment, the LCD screen can be changed to correspond with the current function of the user control 122. The function of each user control 122 in this embodiment would be designated by software instead of hardware. For example, a browse signal might be indicated on the LCD screen when a browser is being viewed on the wireless web access device 110 and a purchase signal might be indicated on the LCD screen when an e-commerce application is being viewed. In another alternative embodiment, the user control 122 would comprise at least one touch-screen, which could be divided into separate “buttons” by software and therefore perform a wide variety of functions. Another alternative embodiment would include a rotating disk under a series of clear buttons where the rotating disk could provide different configurations. For example, there could be a browser setting, a music site setting, an e-commerce setting, etc. A magnifying glass could optionally be used to make the current setting more visible. One skilled in the art would recognize that a wide variety of user controls 122 are possible.

FIG. 3E is a digital photograph of an alternative embodiment of the navigation control unit 120 described in relation to FIG. 2. In this embodiment, the microphone 231 and earpiece 232 are coupled to the navigation control unit 125 by the communication link 233. A variety of user controls 122 are depicted, including clear plastic user controls 122 marked with a label. In this embodiment, these user controls 122 preferably redirect the wireless web access device 110 to a variety of web sites based on the purpose depicted on the user control 122 (e.g., the user's e-mail site, Genie, Football 365, etc.). Also in this embodiment, alternative user controls 180 provide a scrolling functionality. A spring loaded clip 235 permits a user to clip the cord 233 to the user's clothing.

FIGS. 3F-3AU depict a wide variety of isometric views depicting alternative embodiments for the navigation control unit 125. From these figures, one skilled in the art would recognize that an infinite number of possible configurations of the navigation control unit 125 are possible, including different body 330 configurations, locations of communication links 233, types and configurations of user controls 122, connections with the wireless web access device 110, etc. The embodiments depicted in FIGS. 3F-3DQ are generally self explanatory to those skilled in the relevant art based on the detailed description provided herein.

FIG. 3AV depicts an exploded isometric wire frame view of one embodiment of the navigational control unit 120. The navigation control unit 120 is generally teardrop or ‘comma’ shaped in this embodiment. A roughly circular or elliptical arc defines a first end of the navigation control unit 120, and a short, flattened plane or frustum defines a second end. A longitudinal axis extends from the first end to the second end. One side of the navigation control unit 120 is defined by a convex arc extending from the first end to the second end. The other side of the navigation control unit 120 is defined by a roughly circular or slightly elliptical convex portion extending from the first end to about the midpoint of the longitudinal axis and a shallow concave portion extending from the midpoint of the longitudinal axis to the second end, providing the teardrop shape.

In this embodiment, a circuit board 340 provides the centerpiece of the navigational control unit 120 and is generally shaped like the navigation control unit. Beneath the circuit board is a translucent rear cover 342 and an opaque rear over cover 344 that only partially covers the rear cover 342. Above the circuit board is a rubber button layer 346 which is covered by a translucent front cover 348 having cut-outs 349 appropriately placed to allow user controls 122 to penetrate the cover 348. The cut-outs 349 are preferably elliptical or circular in shape, and are located along a convex arc. Additional cut-outs 349 are located near the second end of the navigation control unit 120, close to the longitudinal axis. Alternative cut-outs 349′ is shaped as roughly a half-ellipse and is configured to allow user controls 122 preferably designed for navigation, such as scrolling and enter functions.

First and second opaque front over covers 350 and 351, respectively, placed in front of the front cover. Both the first and second opaque front covers 350, 351 have holes substantially similar in alignment to the cut-outs 349, 349′. Label buttons 352 contain graphics and are placed beneath clear buttons 354 so that the graphics may be visible through the buttons. The buttons are in turn slideably secured within the front cover 348, with upper surfaces of the buttons extending through the cut-outs 349. The front and rear covers 348 and 342 may be ultrasonically welded together to enclose the button rubber 346, circuit board 340, interior portions of the grommets 332, label buttons 352, and interior portions of the buttons 354. The front and rear over covers 350 and 344 may then be secured over the front and rear covers (e.g., by adhesive, ultrasonic welding, or other means), and the front over cover 351 secured within an upper circular recess portion 356 of the front cover. Further information and details regarding aspects of the navigation control unit and its construction may be found in FIGS. 3B-3AV.

Preferably, user controls 122 should be placed on the navigation control unit 120 in a manner that is ergonomically desirable. In one embodiment, the user could hold the navigation control unit 120 in one hand and operate the user controls 122 with the same hand. In this embodiment, the user controls 122 would be placed in a roughly radial arc where they could be easily reached by a typical user's thumb if the navigation control unit 120 was held comfortably in the palm of one hand (as depicted in FIG. 3AV). Alternatively, user controls 122 could be placed anywhere on the navigation control unit 120, including in locations that would require the use of other fingers or two-handed operation.

FIG. 3AW shows a front view and an end view of a preferred embodiment of the navigation control unit 120. In this embodiment, the body 330 is circular in shape. A connector 121 provides a connection to the wireless web access device 110 and a communications link 233 connects with an optional hands-free unit 230. In this embodiment, there are two different types of user controls 122, the navigator key 192 and the rocker switch 190. The navigator key 192 is circular button located in the center of the navigation control unit 120. The navigator key 192 preferably provides the ability for the user to input ‘scroll up’ and ‘scroll down’ commands by actuating the appropriate section of the navigation key 192, which is marked with label indicia. The rocker switch 190 is centered on the navigation control unit 120 and located around the navigator key 192. In this embodiment, the rocker switch 190 has five spokes that provide links to five different web sites. The user can press any of the sections of the rocker switch 190 to actuate the user command associated with that spoke. In one embodiment, labels 191 are placed underneath the rocker switch 190 to identify the function associated with each spoke, and the rocker switch 190 is preferably at least partially transparent.

FIG. 3AX shows alternative isometric views of the navigation control unit 120 described in reference to FIG. 3AW. A wide variety of different shapes of the body 330 and the location and design of the user controls 122, including rocker switches 190, are depicted in this figure. One skilled in the art would recognize that an infinite number of different configurations would be possible.

FIGS. 3AY-3BG show exploded, isometric views of alternative embodiments of the navigation control unit 120 described in reference to FIG. 3AW. In particular, different configurations of the body 330 and the rocker switch 190 are shown. In FIG. 3AY, a graphic cover 195 is described, where the rocker switch 190 is located within the graphic cover 195. The rocker switch 190 is actuated when the user presses down on a spoke, which will activate an actuator 196 to generate a user command. FIG. 3AZ depicts an alternative to FIG. 3AY, where the graphic cover 195 is transparent and a graphic panel 197 is located underneath so that the graphics are visible through the graphic cover 195 and rocker switch 190. FIG. 3BA depicts another alternative where the rocker switch 190 and graphic cover 195 are separate, and the graphic panel 197 is visible through the transparent rocker switch 190.

In FIG. 3BB, the rocker switch 190 is a rubber keypad, where the user presses down a section of the rocker switch 190 and an actuator 196 is activated. The graphic cover 195 is placed on top of the rocker switch 190, and the rocker switch 190 contains label indicia to indicate the function of each spoke. FIG. 3BC is similar to FIG. 3BB, except that the rocker switch 190 is a polycarbonate keypad and the actuator design is accordingly different. FIG. 3BD is another alternative embodiment further comprising a navigator key 192 located in the center of the rocker switch 190.

In FIG. 3BE, the actuator 196 is a force-sensing layer that receives the inputs from the rocker switch 190. In FIG. 3BF, the functions of the rocker switch 190 and the actuator 196 are combined in a membrane keypad 190. In FIG. 3BG, a graphic cover 195 and rocker switch 190, as well as a navigator key 192 are shown, with the label indicia on the rocker switch 190.

FIGS. 3BH-3BM show front views of preferred embodiments of the navigation control unit 120. In FIGS. 3BH-3BM, alternative embodiments of the connection between a wireless web access device 110 and a navigation control unit 120 are shown. In FIG. 3BH, a connector 121 is attached to each navigation control unit 120. Each connector 121 in this embodiment is designed for a particular wireless web access device 110. FIG. 3BI depicts an alternative embodiment where one connector 121 is designed for all navigation control units 120. This connector 121 can be designed for a popular wireless web access device 110, for example. For incompatible wireless web access devices 110, an adaptor 199 can be provided to serve as an interface between the connector 121 and the wireless web access device 110. FIG. 3BJ depicts another alternative embodiment where each navigation control unit 120 has a connector 121 which includes a cable, and adaptors 199 are designed to provide an interface with each type of wireless web access device 110. FIG. 3BK shows another alternative embodiment where the connector 121 does not include a cable, and each adaptor 199 includes both a device-specific connector and a cable. FIG. 3BL shows another alternative embodiment where the connector 121 includes a cable and a device-specific connector and the adaptor 199 includes another device-specific connector and another cable. FIG. 3BM shows another alternative embodiment where the connector 121 and adaptor 199 are effectively combined and the adaptor 199 is mounted directly in the navigation control unit 120. The navigation control unit 120 could contain a universal connector so that it could accept any adaptor 199. One skilled in the art will recognize that other alternative embodiments are possible.

In another alternative embodiment, the connector 121 is a cable that contains a minor amount of memory. The connector 121 would then effectively be on a bus with the processor in the navigation control unit 120. The connector 121 could preferably contain the information necessary to program a given series of wireless web access devices 110. For example, a particular connection 121 could be designed to reprogram Nokia phones. This embodiment reduces the amount of memory needed on the navigation control unit 120.

FIG. 3BN shows a front view of a preferred navigation control unit 120. The navigation control unit 120 has a body 330 and a wide variety of user controls 122. One user control is the hot key 123, which is configured to link to a web site after actuated by the user. Other user controls 122 include one or more navigation keys 192, which preferably direct the user's navigation of a web page. Navigation functions can include ‘scroll up’, ‘scroll down’, ‘okay’, ‘enter’, ‘refresh’, etc. In this embodiment, an e-mail key 193 is also included to automatically direct the user to an e-mail portal and a start/stop key 194 is also included to provide start and stop functionality.

FIGS. 3BO-3CT depict a wide variety of isometric views depicting alternative embodiments for the navigation control unit 120. From these figures, one skilled in the art would recognize that an infinite number of possible configurations of the navigation control unit 120 are possible, including different body 330 configurations, locations of communication links 233, types and configurations of user controls 122, connections with the wireless web access device 110, etc. The embodiments depicted in FIGS. 3BO-3CT are generally self explanatory to those skilled in the relevant art based on the detailed description provided herein.

FIGS. 3CU-3CZ depict isometric views of alternative embodiments of the navigation control unit 120. In FIGS. 3CU-3CZ, the navigation control units further comprise a SIM Card 702. The SIM (Subscriber Identity Module) Card 702, or smart card, contains a microchip, microprocessor, and memory and is used to be inserted into a wireless web access device 110 such as a cell phone, and the SIM Card 702 preferably contains all subscriber-related data. In these embodiments, a SIM Card 702 is inserted into a navigation control unit 120 to provide user information. In this way, the navigation control unit 702 could be made generically, and thus less expensive, and used by different users. In one embodiment, the user can purchase a generic navigation control unit 120, insert their SIM Card 702, and have all their expected functionality and be identified to the navigation server 125, so that custom redirection can take place.

FIGS. 3DA-3DK depict a wide variety of isometric views depicting alternative embodiments for the navigation control unit 120. From these figures, one skilled in the art would recognize that an infinite number of possible configurations of the navigation control unit 120 are possible, including different body 330 configurations, locations of communication links 233, types and configurations of user controls 122, connections with the wireless web access device 110, etc. The embodiments depicted in FIGS. 3DA-3DK are generally self explanatory to those skilled in the relevant art based on the detailed description provided herein.

FIG. 3DA depicts an alternative embodiment of the navigation control unit 120 where the body 330 is shaped like a watch and can be worn on the user's wrist like a watch. FIG. 3DI depicts an alternative embodiment of the navigation control unit 120 where a user cartridge 704 can be attached to the navigation control unit 120 to provide additional information or functionality. For example, the user cartridge 704 can function as a smart card or SIM Card 702, can provide addition functionality, can provide user information, etc. A user could have a variety of user cartridges 704 to plug-in whenever they wanted to perform different functions with the navigation control unit 120 (e.g., having an Internet banking, surfing, and e-mail cartridges).

FIG. 3DL depicts a cut-away side view of an alternative embodiment of the navigation control unit 120. FIG. 3DL is a close-up of part of FIG. 3BM. In FIG. 3DL, an embodiment of a connector 121 for a navigation control unit 120 is shown. In this embodiment, the connector 121 slides or is inserted into the body 330 of the navigation control unit 121 and a connector assembly 373 automatically captures the connector 121. This capture could be a permanent capture or a release mechanism (not shown) could be provided. If capture of the connector 121 is permanent, then the navigation control unit may be coupled to the wireless web access device once, and then have the unit retained to the wireless device securely thereafter. A strain relief device 372 is provided around the connector 121 and in the body 330 to prevent failure of the connector assembly 373 when various forces, stresses, and strains are applied to the body. The body 330 has a casing top and a casing bottom A main PCB 374 is mounted on one inside surface of the body, and an upper stacker 376 is mounted to the main PCB 374. The upper stacker 376 has a cone-shaped protuberance with a tip. A lower stacker 380 is mounted on the opposite inner surface of the body 330 from the upper stacker 376, and a secondary PCB 378 is mounted on the lower stacker 380. The point of the upper stacker 376 preferably touches the secondary PCB 378. The secondary PCB 378 is affixed to the strain relief device 372 to help securably attach the strain relief device 372 to the body 330.

The connector 121 preferably slides into the strain relief device 372, which attaches the connector 121 to the navigation control unit 120, forming the connector assembly 373. This embodiment provides an improved connection for the user, with increased ease of use and stability. One skilled in the art will recognize from FIG. 3DL and this description that many alternative embodiments of the connector assembly 373, strain relief device 372, and other aspects of this embodiment are possible.

FIGS. 3DM-3DQ are isometric views of alternative packaging embodiments for marketing the navigation control unit. As shown in these FIGS., the navigation control unit may be packaged in various forms, depending upon how the navigation control unit is configured (as described herein).

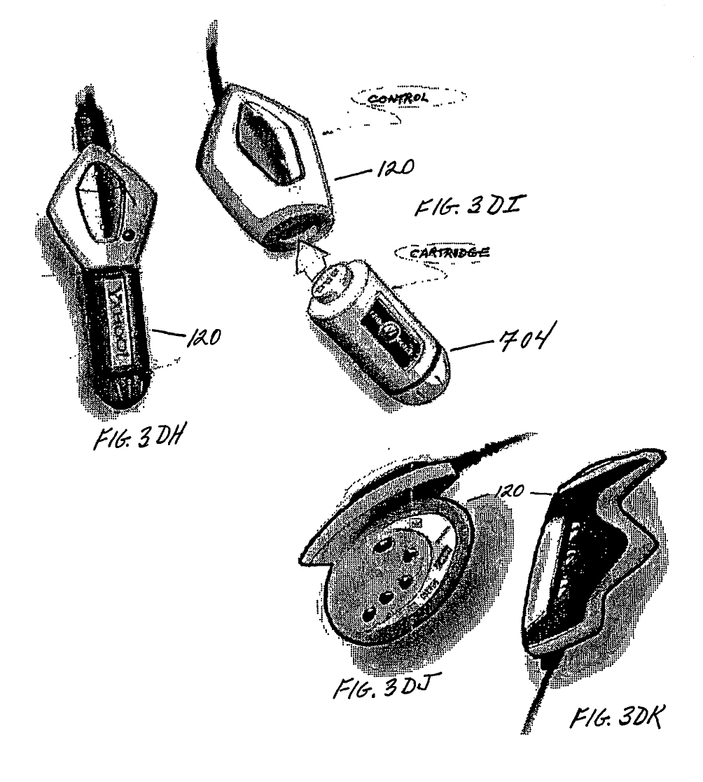

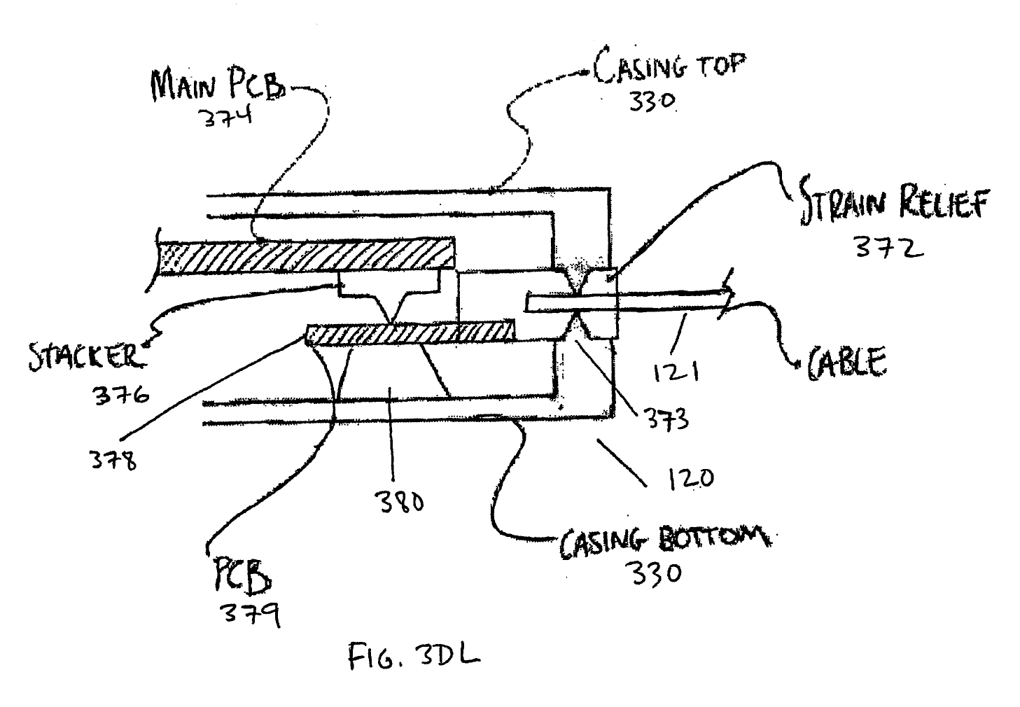

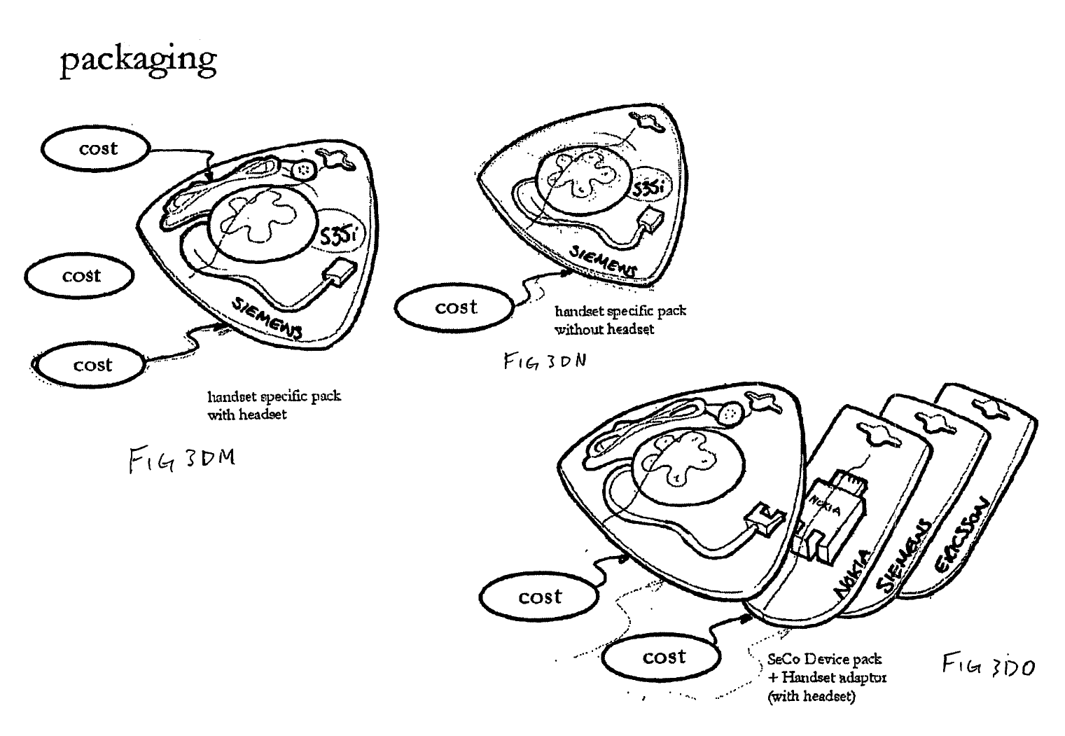

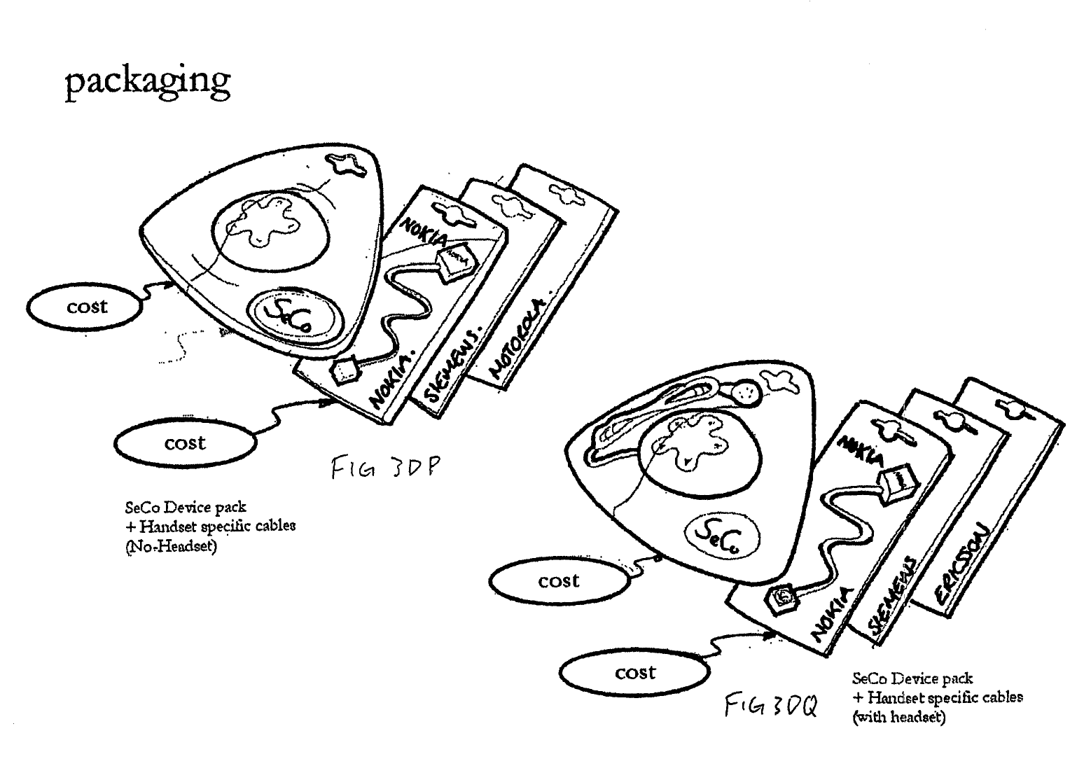

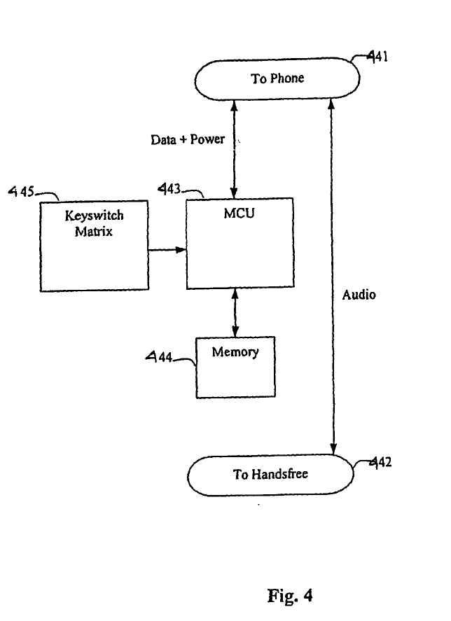

FIG. 4 shows a preferred circuit construction for the navigation control unit 120. A first i/o port 441 communicates with the wireless web access device 110. In one example, the i/o port 441 uses an RS232 communications interface. Communications are governed by a protocol such as GSM07.07. Power, for example at +3.3V or +5V and GND, is drawn through the port 441 from the host wireless web access device 110, or an independent power source is provided. The independent power source could be any suitable power source, including but not limited to batteries, solar-generated power, or power provided by another device, such as an automobile cigarette lighter, a wall outlet, or power source associated with a personal computer. Suitably, audio signals are passed directly from the first i/o port 441 to a second i/o port 442. The second i/o port 442 is coupled to the handsfree unit 230.

The navigation control unit 120 comprises a microprocessor 443 for executing instructions stored on an internal or external memory such as an EPROM, and coupled to internal or external temporary storage 444 such as SDRAM. The microprocessor 443 is coupled to the user controls 122 such as through a keyswitch matrix 445. Further details regarding circuitry and configuration of the navigation control unit may be found in U.S. patent application Ser. No. ______, entitled “Navigation Control Unit for a Wireless Computer Resource Access Device, such as a Wireless Web Content Access Device,” filed concurrently herewith.

Operation of the navigation control unit 120 will now be described with reference to the flowchart of FIG. 5 as a routine 500. Each of the blocks depicted in FIG. 5 and the other flowcharts is of a sub-operation type that is either well known in the art or may be implemented by those skilled in the relevant art based on the detailed description provided herein. Each block may well include a sequence of operations that need not be described herein. Those skilled in the relevant art can create source code, microcode, or otherwise implement the invention based on the flowchart of FIG. 5 and the detailed description provided herein for operating the navigation control unit. The routine 500 is preferably stored in non-volatile memory that forms part of the microprocessor 443 or memory 444, or can be stored in removable media, such as disks, or hardwired or preprogrammed in chips, such as EEPROM semiconductor chips. Those skilled in the relevant art will appreciate that some or all of the routine 500 and other functions and methods described herein can be performed by an application specific integrated circuit (ASIC), by a digital signal processing (DSP) integrated circuit, through conventional programmed logic arrays or circuit elements.

At step 501 the navigation control unit 120 is powered on, such as by the navigation control unit 120 being connected to the wireless web access device 110 or by the wireless web access device 110 being turned on. At step 502 communications with the web access device 110 are initialized. For example, communication settings such as baud rate are negotiated. Preferably, an identify request is sent to the web access device 110 and a reply received giving identity information of the web access device 110 such as make and model information. In one embodiment, if the identity information is not received or is not recognized, operation ends at step 503.

At step 504 the navigation control unit 120 optionally sets configuration parameters of the wireless web access device 110 using configuration commands.

In step 505 the navigation control unit 120 waits for user input such as by polling the keyswitch matrix 445 (as described in relation to FIG. 4). The user controls 122 monitored in step 505 perform any suitable function. In response, at step 506 the navigation control unit 120 sends control commands to the wireless web access device 110.

Operation continues until power to the navigation control unit 120 is removed, such as when the navigation control unit 120 is disconnected from the wireless web access device 110 or when the wireless web access device 110 is turned off.

The configuration commands in step 504 are used to set a wide variety of configuration parameters of the web access device 110. The configuration parameters are determined by the nature and type of the wireless web access device 110. In the example of a GSM cellular device, the wireless web access device 110 dials a predetermined network number when attempting to establish a connection to the Internet through a predetermined gateway portal. The gateway portal is one example configuration parameter that may be set by the navigation control unit 120. Other configuration parameters may set screen displays including predetermined logos and advertising information. Still other configuration parameters of the wireless web access device 110 include, for example, a home page, bookmarks stored by the wireless web access device 110, and a ringing tone of the wireless web access device 110. The navigation control unit 120 conveniently sets these and other configuration parameters of the wireless web access device 110 for the user automatically and requiring minimal or even no user input. Advantageously, the user avoids navigation of complicated button press arrangements and menu structures in the wireless web access device 110. Also, where configuration parameters are sent over a live network connection, usage of network bandwidth and network time is substantially reduced by the automatic operation of the navigation control unit 120 compared with manual keypresses of the integral user controls 112 by the user.

The commands sent by the navigation control unit 120 in step 506 can be any sort of commands. In one preferred embodiment, the commands are a command sequence understandable by the wireless web access device 110. In one embodiment, the commands sent by the navigation control unit 120 represent a keypress sequence equivalent to a sequence of manual keypresses on the integral user controls 112. In the simplest example, each command sent to the wireless web access device 110 is equivalent to a single press on one of the integral user controls 112. In this embodiment, each command is a string representing a predetermined sequence of keypresses. The keypress representation is preferably determined with reference to the identity information obtained in step 502, such that the navigation control unit 120 is able to operate with a wide variety of wireless web access devices 110. In one embodiment, the keypress sequence is obtained with reference to a lookup table stored in the navigation control unit 120, such that each user control 122 maps to a plurality of stored keypress sequences and one of the keypress sequences is selected according to the identity information of the wireless web access device 110. The keypress sequence is then used to form the command or a sequence of commands, depending upon the communication protocol required for communication with the identified web access device 110. In another embodiment, the command includes a combination of wireless web access device commands and keypress commands. For example, the command could include a power on command, a select browser commands, and then a keypress combination representing a series of single presses of the integral user control buttons 112.

The control commands sent in step 506 will now be described in more detail. A first group of user controls 122 represent most commonly used functions suitable for controlling the wireless web access device 110. One common functionality would be navigation functions for navigation of a local or global computer network using commands such as back, forward, stop, refresh, scroll up, scroll down and select These first group of user controls 122 may directly replicate equivalent integral user controls 112 on the wireless web access device 110. It is advantageous to provide these simple user controls on the navigation control unit 120. The navigation control unit 120 has user controls 122 which are easier to use than the integral user controls 112 of the wireless web access device 110, for example by being larger or having improved ergonomics.

Another group of the user controls 122 provide improved functionality over the integral control buttons 112. This second group of controls perform higher level functions (described below). The navigation control unit 120 may have only the first group, or only the second group, or preferably both groups of user controls 122, or any combination of user controls 122.

Preferably, one actuation of the user controls 122 of the navigation control unit 120 represents a plurality of button presses required to perform the equivalent function using the integral user controls 112 of the wireless web access device 110. The controls may perform a wide variety of higher level functions, depending on the nature and type of the wireless web access device 110.

In one embodiment, one actuation of the user controls 122 of the navigation control unit 120 represents an e-commerce or purchase command. For example, the user control 122 could be configured as a “purchase” button and a command would be sent to the e-commerce web page requesting to purchase a product. A retailer could sell navigation control units 120 that contained a user control 122 programmed to purchase, say, the book-of-the-month and proceed to complete the e-commerce transaction based on payment and delivery information stored on a server. In an alternative embodiment, an electronic cash chip or e-wallet coupled with the navigation control unit 120 could be used to provide payment. In another alternative embodiment, a user control 122 could provide identification or authentication information about the user of the navigation control unit 120.

In one example, a selected one or more of the user controls 122 have a pre-defined hot key, or predefined link, function (depicted as hot key user controls 123). These user controls 122 each command the wireless web access device 110 to open a connection to a particular web site. Each of these user controls 122 links to a predetermined site, such that the user may easily access a selected few predetermined sites very conveniently. Advantageously, the user obtains access to these predetermined web sites without having to use or even understand other navigation controls on the wireless web access device 110 or on the control unit 120.

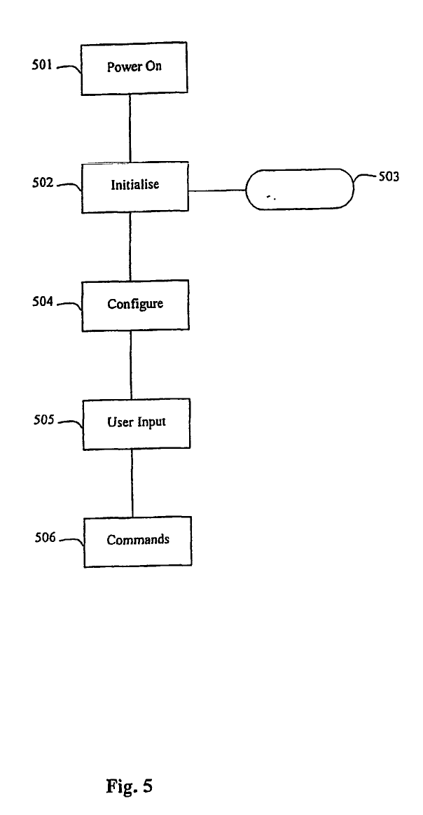

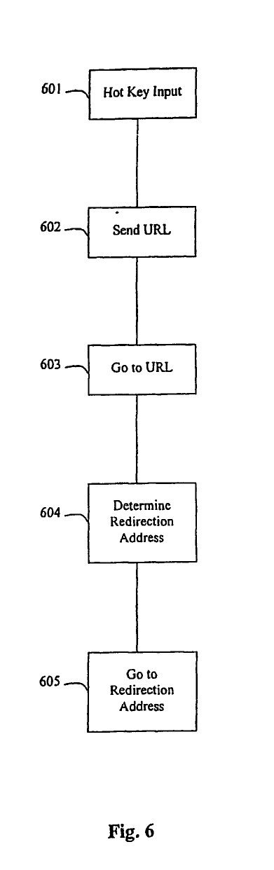

FIG. 6 shows a preferred method for performing higher level controls such as the hot key function 123 of a user control 122. At step 601 a user control 122 is activated or actuated by the user.

At step 602 the navigation control unit 120 sends control commands to the wireless web access device 110. These control commands may depend upon the current state of the wireless web access device 110, such as establishing a web connection or opening a browser function if required. The control commands include sending a URL. Conveniently, the URL is sent as a keypress sequence.

In one example, the URL comprises three fields. A first field gives a web address, preferably in a standard format such as “http://www.serveraddress.xxx”. A second field provides an identifier unique to the navigation control unit 120, or unique to a predetermined group of navigation control units, such as an alphanumeric sequence of 6, 8 or 10 characters allocated to the navigation control unit 120 during manufacture. In this example the unique identifier is “XXX12345”. The third field identifies the user control 122 activated by the user as determined in step 601. In this example the user activated key number “3”. The complete URL is sent, for example, as the character sequence S “http://www.serveraddress.xxx/xxx12345/3”.

The URL may require a complicated keypress sequence. A wireless web access device 110 may have integral user controls 112 in a 4×3 number keypad layout, where each number key is used to obtain an extended alphanumeric character set by repeated keypresses. For example, the “1” button is pressed twice to give the letter “A”, or pressed three times to give the letter “B”. Hence, entering the URL manually requires many keypresses on the integral user controls 112. In the above example, the URL contains 39 characters, each of which may require several button presses by the user on the integral user controls 112, typically at least a total of 60 presses. By contrast, the user need only perform one keypress on the pre-defined user control 122 of the navigation control unit 120 to achieve the same result, giving a significant advantage.

In step 603 the wireless web access device 110 responds to the URL and attempts to access the web address identified by the URL, using browser functions within the wireless web access device 110. The first field preferably identifies a predetermined navigation server 125, which receives the URL request from the wireless web access device 110.

In step 604 the navigation server 125 uses the second and third fields of the URL to determine a redirection address, and returns the redirection address to the wireless web access device 110. The redirection address is a second URL. At step 605 the wireless web access device 110 is redirected to the redirection address supplied from the navigation server 125.

The redirection address is conveniently determined with reference to a lookup table stored on the navigation server 125. In this example, the second and third fields provide the information “XXX12345/3” and the redirection address is returned as a website corresponding to user controls 122 number “3” on navigation control unit 120 number “XXX12345”. The website may be visibly labeled on the user control 122 or adjacent thereto for the user. For example, the user control 122 number “3” is labeled “weather” and the redirection address corresponds to a website giving weather information.

The redirection action takes place at the navigation server 125, such that the navigation control unit 120 is relatively dumb. Also, if the location of the desired website changes or if it is desired to substitute another website, then reprogramming is performed centrally at the navigation server 125.

In a preferred embodiment, the navigation control unit 120 stores user specific information, and such information is delivered to the wireless web access device 110, for example, when accessing a particular predetermined website from one of the user controls 122. Additionally or alternatively, such user information is supplied from the navigation control unit 120 in response to an interrogation signal issued from the wireless web access device 110.

In a typical wireless web access device 110, navigation generally takes place using software controls within the device using the integral user controls 112. However, in the preferred embodiment of the present invention the navigation control unit 120 provides an external hardware controller to determine navigation of the wireless web access device 110. The navigation control unit 120 readily links to predetermined web sites that are of interest to the user. The user controls 122 may be tailored to the needs of each user, such as providing financial, travel, sports or any other information, by changing the central lookup table or personalization table at the navigation server 125. The unique identifier allows each navigation control unit to have a different response, based on the redirection addresses stored at the navigation server. Further information regarding the navigation server and operation of the system described herein may be found in U.S. patent application Ser. Nos. ______ and ______, entitled “Navigation Server for Use with, for Example, a Wireless Web Access Device Having a Navigation Control Unit,” and “Software for a Navigation Control Unit for Use with a Wireless Computer Resource Access Device and Associated System,” both filed concurrently herewith.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other resource access systems, not necessarily for the web-based and wireless system described above. The elements and acts of the various embodiments described above can be combined to provide further embodiments.

All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all systems that operate under the claims to provide a method for providing access to computer resources. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. A navigation control unit apparatus for coupling with a wireless web access device, comprising:
a body, wherein the body has an outer surface and an inner surface;
a connector for coupling with a wireless access device, wherein the connector is operably secured to the body;
at least one user control, wherein the at least one user control is operably retained by the body, and wherein further at least a user controllable portion of the at least one user control is accessible from outside the body; and
circuitry including a processor, wherein the circuitry is retained within the body and is configured to generate a user command based on actuation of the at least one user control and transmit the user command to the wireless web access device.

2. The apparatus of claim 1 further comprising at least one grommet positioned between the connector and the body.

3. The apparatus of claim 1 further comprising a mat of elastomeric material placed on at least a portion of the outer surface of the body.

4. The apparatus of claim 1 wherein the connector rigidly couples the navigation control unit and the wireless web access device in close proximity to each other.

5. The apparatus of claim 1 wherein the connector is a communications link.

6. The apparatus of claim 5 wherein the communications link is a local wireless link.

7. The apparatus of claim 5 wherein the communications link is a cord.

8. The apparatus of claim 1 wherein the body is composed primarily of poly-carbonate based plastic.

9. The apparatus of claim 1 further comprising a light source coupled to the circuitry and positioned within the body, wherein the light source provides back lighting to at least one user control.

10. The apparatus of claim 1 wherein the body includes a port configured to allow the insertion and removal of removable devices.

11. The apparatus of claim 10 wherein the removable device is a smart card.

12. The apparatus of claim 10 wherein the removable device provides authentication information.

13. The apparatus of claim 10 wherein the removable device assisting in providing security for user data.

14. The apparatus of claim 10 wherein the removable device is a Bluetooth-enabled device.

15. The apparatus of claim 1 further comprising a handsfree unit operably connected with the body and the circuitry, the handsfree unit including an earpiece and a microphone.

16. The apparatus of claim 1 further comprising a plurality of user controls, wherein the user controls are buttons placed approximately in a radial arc.

17. The apparatus of claim 1 further comprising a plurality of user controls, wherein the user controls are positioned with respect to the body so that the navigation control unit and user controls can be used comfortably with one hand.

18. The apparatus of claim 1 further comprising an internal power source within the body.

19. The apparatus of claim 1 wherein the connector provides a conduit for electrical power.

20. The apparatus of claim 1 wherein the at least one user control includes at least one of the following user controls: a button, a thumb pad, a joystick, a software button on a touch screen, a lever, a button whose purpose is identified by a rotating disk, a sunken button, a clear plastic button, a dial and a data entry device.

21. The apparatus of claim 1 further comprising an LCD screen to display information to the user of the navigation control device.

22. The apparatus of claim 1 wherein the body is shaped like a writing instrument.

23. The apparatus of claim 1 wherein the body is a watch body.

24. The apparatus of claim 1 wherein the body is attached to a battery for a wireless web access device.

25. The apparatus of claim 1 wherein the body is constructed as an ultrasonically-welded clamshell.

26. The apparatus of claim 1 wherein the body is composed of two halves attached together.

27. The apparatus of claim 1, wherein a length along a longitudinal axis of the body is between 0.75 inches and 4 inches, wherein a width of the body is between 0.75 inches and 4 inches, and wherein further a thickness of the body is between 0.1 inches and 0.8 inches.

28. The apparatus of claim 1 wherein the body is sized and shaped to fit within the palm of an adult human user's hand.

29. The apparatus of claim 1 wherein the thickness of the body is 0.45 inches or more.

30. The apparatus of claim 1 wherein the wireless web access device is a mobile phone.

31. The apparatus of claim 1 wherein the wireless web access device is a PDA.

32. A navigation control unit apparatus for coupling with a wireless computer resource access device, comprising:
a housing, wherein the body has an outer portion and an inner portion;
an interface configured for coupling with the wireless computer resource access device; and
circuitry including a processor and a plurality of user-actuatable switches, wherein the circuitry is coupled to the interface and is retained within the housing, wherein at least a user controllable portion of the switches are accessible for actuation from outside the body, and wherein the circuitry is configured to generate a user command based on actuation of one of the switches and transmit the user command to the wireless computer resource access device.

33. The apparatus of claim 32, farther comprising a plurality of transparent buttons operably retained by the housing near respective switches, and a plurality of respective labels removably secured between an underside of each button and an upper surface of each switch.

34. The apparatus of claim 32, further comprising a plurality of buttons operably retained by the housing near respective switches, wherein the buttons are sized to receive user fingertip actuation.

35. The apparatus of claim 32 wherein the housing is sized and shaped to fit within the palm of an adult human user's hand.
